(19) United States
(12) Patent Application Publication
(10) Pub. No.: US 2026/0292924 A1
(43) Pub. Date: Sep. 24, 2026

(54) RADIO ACCESS NETWORK NODE, RADIO TERMINAL, AND METHODS THEREOF

(71) Applicant: NEC Corporation, Tokyo (JP)

(72) Inventor: Takahiro SASAKI, Tokyo (JP)

(73) Assignee: NEC Corporation, Tokyo (JP)

(21) Appl. No.: 19/472,860

(22) PCT Filed: Apr. 4, 2024
(86) PCT No.: PCT/JP2024/013928

§ 371 Date: Oct. 6, 2025

(30) Foreign Application Priority Data
Apr. 21, 2023 (JP) 2023-070075

(51) Int. Cl. H04W 76/28

(52) U.S. Cl. CPC H04W 76/28

(57) ABSTRACT

A radio access network node transmits configuration information for cell DTX or cell DRX (cell DTX/DRX) to one or more radio terminals in a cell. The configuration information includes a first field or information element indicating a length of a cell DTX/DRX cycle. The configuration information further includes a second field or information element that explicitly or implicitly indicates how many segments the cell DTX/DRX cycle is divided into, and a third field or information element that indicates a number of one or more segments that define an ON duration within the cell DTX/DRX cycle. This can improve cell DTX/DRX. For example, it can provide a specific method for a network to configure the ON duration of cell DTX/DRX in radio terminals.

### TECHNICAL FIELD

The present disclosure relates to radio communication networks, and, more specifically, to various technologies that contribute to improving network energy saving, either directly or indirectly.

### BACKGROUND ART

The 3rd Generation Partnership Project (3GPP (registered trademark)) Release 15 and subsequent releases specify 5G New Radio (NR) User Equipment (UE) power saving schemes. These UE power saving schemes include discontinuous reception (DRX) performed by a UE in Radio Resource Control (RRC)_CONNECTED mode (see, for example, Non-Patent Literature 1-3). In this description, DRX performed by a UE in RRC_CONNECTED mode is referred to as connected mode DRX (CDRX), to distinguish it from cell discontinuous transmission (DTX) and cell DRX, which are described below.

Clause 11 of Non-Patent Literature 1 states that the Physical Downlink Control Channel (PDCCH) monitoring activity of a UE in RRC CONNECTED mode is governed by CDRX. If CDRX is configured, the UE does not need to continuously monitor a PDCCH. CDRX is characterized by its on-duration, inactivity timer, retransmission timer, cycle, and active time. The on-duration is the duration that the UE waits, after waking up, to receive PDCCHs. If the UE successfully decodes a PDCCH, it stays awake and starts the inactivity timer. The inactivity timer is the duration that the UE waits to successfully decode a next PDCCH from the last successful decoding of a PDCCH. If PDCCH decoding fails until the inactive timer expires, the UE can return to sleep. The retransmission timer is the duration during which the UE must be awake to receive retransmissions. The DRX cycle specifies a periodic repetition of the on-duration, followed by a period of possible inactivity. The active time is the total duration during which the UE monitors a PDCCH. The active time includes the on-duration within a DRX cycle, the time during which the UE performs continuous reception while the inactivity timer has not expired, and the time during which the UE performs continuous reception while waiting for a retransmission opportunity.

Clause 5.7 of Non-Patent Literature 2 describes the CDRX-related timers and the details of their start and stop conditions. CDRX is controlled by RRC. The CDRX-related parameters provided to the UE from the network by the RRC configuration (DRX-Config) include the following: drx-onDurationTimer, drx-SlotOffset, drx-Inactivity Timer, drx-Retransmission TimerDL (per DL HARQ process except for the broadcast process), drx-Retransmission TimerUL (per UL HARQ process), drx-LongCycleStartOffset, drx-ShortCycle (optional), drx-ShortCycleTimer (optional), drx-HARQ-RTT-TimerDL (per DL HARQ process except for the broadcast process), and drx-HARQ-RTT-TimerUL (per UL HARQ process). Multiple serving cells of a Medium Access Control (MAC) entity of the UE may be configured by the RRC with two CDRX groups having different CDRX parameters. Although the term “DRX group” is used in the 3GPP specification, this description uses the term “CDRX group” for clarity. If two CDRX groups are configured, each serving cell is uniquely assigned to one of the two groups. The CDRX parameters that are configured individually for each CDRX group are drx-onDurationTimer and drx-Inactivity Timer. On the other hand, the CDRX parameters common to the multiple CDRX groups are drx-SlotOffset, drx-Retransmission TimerDL, drx-Retransmission TimerUL, drx-LongCycleStartOffset, drx-ShortCycle (optional), drx-ShortCycleTimer (optional), drx-HARQ-RTT-TimerDL, and drx-HARQ-RTT-TimerUL.

If CDRX is configured, the active time for multiple serving cells in a CDRX group includes, among other time periods, the time while:
the drx-onDuration Timer or drx-Inactivity Timer configured for the CDRX group is running; or
the drx-RetransmissionTimerDL or drx-RetransmissionTimerUL is running on any of the serving cells in the CDRX group; or
a scheduling request is sent on a Physical Uplink Control Channel (PUCCH) and is pending; or
a PDCCH indicating a new transmission to the Cell Radio Network Temporary Identifier (C-RNTI) of the MAC entity has not been received after successful reception of a random access response to a random access preamble not selected by the MAC entity.

Non-Patent Literature 3 specifies that an RRC configuration related to CDRX (i.e., DRX-Config) is provided to the UE by the network via a UE-dedicated RRC message, specifically an RRCReconfiguration message. The DRX-Config is contained in a MAC-CellGroupConfig within a CellGroupConfig carried by an RRCReconfiguration message.

The 3GPP is currently discussing network energy saving for 3GPP Release 18 (see, for example, Non-Patent Literature 4-13). Network energy saving is abbreviated as NES. As described in Non-Patent Literature 4, there are various technologies for improving network energy saving, including cell DTX and cell DRX. For example, the network may provide a mechanism for notifying UEs in a cell whether the cell is in an inactive state. During cell DTX or cell DRX, i.e., while the cell is in an inactive state, the cell may not transmit or receive, or it may only perform restricted transmission or reception. For instance, the cell does not need to transmit or receive some periodic signals and channels, such as cell common channels and signals and UE-specific signals and channels.

The term “cell DTX/DRX” may be used to refer to either or both of cell DTX and cell DRX. Also, although the definitions of terms for cell DTX/DRX are not clear at present, in this description, the terms “cell DTX ON duration,” “cell DTX off duration,” “cell DRX ON duration,” and “cell DRX off duration” are used with respect to cell DTX/DRX. The cell DTX/DRX ON duration refers to the duration, time, or period during which a cell is active and can transmit and receive all necessary cell common channels and signals, as well as UE-specific signals and channels. In contrast, the cell DTX/DRX off duration refers to the duration, time, or period during which the cell is in an inactive state for NES and does not transmit or receive, or is allowed to maintain only restricted transmission or reception. The cell DTX/DRX ON duration may also be referred to as the cell DTX/DRX ON time or period, or the cell DTX/DRX active time, period, or duration. The cell DTX/DRX off duration may also be referred to as the cell DTX/DRX off time or off period, or the cell DTX/DRX inactive (or non-active) time, period, or duration.

Clause 6.1.4 of Non-Patent Literature 4 describes examples of signals that a gNB stops transmitting or receiving during cell DTX/DRX operation in a non-active period. In the first example, during the cell DTX/DRX off duration, the cell or gNB is expected to turn off all transmission or reception of data traffic and reference signals. In the second example, during the cell DTX/DRX off duration, the cell or gNB is expected to turn off only the transmission or reception of data traffic. That is, the gNB continues to transmit or receive reference signals. In the third example, during the cell DTX/DRX off duration, the cell or gNB is expected to turn off dynamic data transmission or reception. That is, the gNB is expected to continue transmitting or receiving on periodic resources such as Semi-Persistent Scheduling (SPS), Configured Grant (CG) Physical Uplink Shared Channel (PUSCH), Scheduling Request (SR), Random Access Channel (RACH), and Sounding Reference Signal (SRS). In the fourth example, during the cell DTX off duration, the cell or gNB is expected to transmit only reference signals (e.g., Channel State Information Reference Signal (CSI-RS) for measurement). Cell DTX and cell DRX can be configured and operated separately (e.g., one RRC configuration set for downlink and another RRC configuration set for uplink). Cell DTX and cell DRX can also be configured and operated together. For each cell DTX/DRX configuration, parameters including at least periodicity, start slot or offset, and ON duration can be configured.

Clause 6.1.4 of Non-Patent Literature 4 states that the cell DTX/DRX mode can be activated and deactivated via dynamic Layer 1 or Layer 2 (L1/L2) signaling and UE-specific RRC signaling. Both UE-specific L1/L2 signaling and common L1/L2 signaling can be considered for the activation and deactivation of the cell DTX/DRX mode.

Clause 6.1.4 of Non-Patent Literature 4 states that it is beneficial to align UE CDRX with cell DTX and to align DRX between multiple UEs. In addition, Clause 6.1.4 of Non-Patent Literature 4 states that cell DTX/DRX information needs to be exchanged and coordinated between neighboring gNBs. A gNB can use the received cell DTX/DRX information to determine its own cell DTX/DRX configuration for the purpose of network energy savings.

Section 2.1 of Non-Patent Literature 5 presents the problem that the semi-static configuration of cell DTX/DRX pattern may not be suitable for various traffic models and is not beneficial for network energy savings when the UE experiences time-intensive traffic. In order to support flexible services, Non-Patent Literature 5 proposes to consider L1 signaling that dynamically indicates cell DTX/DRX pattern. More specifically, Non-Patent Literature 5 proposes that at least activating and deactivating the cell DTX/DRX pattern, for example, switching the cell DTX/DRX pattern between multiple cell DTX/DRX patterns and dynamically activating the cell DTX/DRX ON duration, should be considered as indication information of L1 signaling.

Section 2.2 of Non-Patent Literature 5 describes the alignment of cell DTX and UE CDRX. Non-Patent Literature 5 indicates that aligning the cell DTX ON duration and the UE CDRX ON duration, specifically, setting the UE CDRX ON duration of all UEs in a cell to fall within the cell DTX ON duration of the cell, can ensure data scheduling with lower latency and provide a longer cell DTX OFF duration. In order to achieve alignment between cell DTX/DRX and UE CDRX, Non-Patent Literature 5 proposes indicating the UE CDRX start offset in L1 signaling, thereby adapting to dynamic indication of the cell DTX/DRX pattern.

Non-Patent Literature 6 describes whether L1/L2 signaling is used to configure a DTX/DRX pattern or only used to activate a DTX/DRX pattern configured by RRC. Non-Patent Literature 6 introduces three options that were proposed to understand the agreement reached at the previous 3GPP Technical Specification Group (TSG) Radio Access Network (RAN) Working Group #2 (WG2) (RAN2) meeting that “Periodic DTX is assumed as a baseline. The gNB provides indication to UE about NW DTX mode/configuration via dedicated dynamic L1/L2 signalling”. Option 1 allows both a periodic DTX/DRX pattern configured by RRC and a one-shot pattern (re)configured by L1/L2 signaling. Option 2 allows a periodic pattern configured by RRC and uses L1/L2 signaling to activate it. Option 3 allows both a periodic pattern (configured by RRC) and a one-shot pattern, where the inactive period (off duration) of the one-shot pattern is dynamically activated by L1/L2 signaling, and the duration of the one-shot pattern is configured by RRC. Non-Patent Literature 6 proposes that the meaning of the prior agreement should be confirmed as Option 2, i.e., that a periodic cell DTX/DRX pattern can be configured by RRC and activated by L1/L2 signaling.

Non-Patent Literature 6 describes whether L1/L2 signaling for cell DTX/DRX activation is UE-specific or group-common. Non-Patent Literature 6 suggests that both UE-specific and group-common L1/L2 signaling can be considered for cell DTX/DRX pattern activation.

Non-Patent Literature 6 describes whether multiple sets of cell DTX/DRX configurations or modes can be configured by RRC. Non-Patent Literature 6 describes that, in one option, multiple sets of cell DTX/DRX configurations can be configured by RRC, and L1/L2 signaling can be used to activate the applicable configuration set.

Furthermore, Non-Patent Literature 6 describes joint or separate configuration of cell DTX mode and cell DRX mode. Non-Patent Literature 6 states that, in one option, cell DTX and cell DRX can be configured jointly, and common periodicity and ON duration are used if both cell DTX and cell DRX are activated.

Non-Patent Literature 7 is related to Non-Patent Literature 6 and covers similar topics.

Non-Patent Literature 8 states that, similar to the UE long CDRX cycle pattern, the cell DTX/DRX pattern can be defined by at least the ON duration, periodicity, slot offset (indicating the start point of the ON duration), and inactivity timer. Non-Patent Literature 8 states that, with regard to cell DTX/DRX pattern configuration, the parameters of cell DTX/DRX can be expressed in units of subframes (or milliseconds) in the same way as UE long CDRX cycles.

Non-Patent Literature 9 describes cell selection and reselection by NES-capable UEs. Section 2.2 of Non-Patent Literature 9 states that it is desirable to change the criteria for triggering intra-frequency measurements and inter-frequency or inter-Radio Access Technologies (RATs) measurements for cell reselection, depending on the NES state of the serving cell. Non-Patent Literature 9 proposes that an NES-capable UE can be configured to apply negative offsets to signal level measurements of the serving NES cell in order to start intra-frequency or inter-frequency/inter-RAT neighbor cell measurements when the camping cell enters NES mode.

As described in Non-Patent Literature 4, 3GPP RAN2 has agreed that cell DTX mode and cell DRX mode can be configured per serving cell and operated separately or simultaneously. Based on this agreement, Non-Patent Literature 10 states that it is natural to reuse the existing System Information (SI) mechanism to deliver the cell-wise configurations of cell DTX/DRX in a grouping-like way. Non-Patent Literature 10 proposes to agree on adding a Release-18 NES System Information Block (SIB) and system information procedures to be used to broadcast and update the cell DTX/DRX configurations.

Non-Patent Literature 11 proposes that multiple configurations for cell DTX/DRX patterns can be separately configured by RRC signaling (e.g., DTX/DRX with certain configurations, cell off, etc.). Non-Patent Literature 11 states that, in common L1/L2 signaling, rather than introducing a new Downlink Control Information (DCI) format or a new MAC Control Element (CE), it is reasonable to reuse, for example, paging DCI (e.g., short message reservation bits) or other common DCI that is monitored by all UEs, without increasing UE energy consumption or specification complexity. Non-Patent Literature 11 proposes using L1 signaling, for example, the reserved bits in the short message in the paging DCI or other common DCI, as common signaling to indicate which cell DTX/DRX configuration to activate.

According to Non-Patent Literature 12, one of the agreements reached at the 3 GPP RAN 2 Meeting #121 is that the cell DRX/DTX pattern configuration is common for Release 18 UEs in the cell.

Non-Patent Literature 13 describes that a RAN node (gNB) transmits a cell state indication regarding cell DTX/DRX to other RAN nodes. Non-Patent Literature 13 suggests that the cell DTX/DRX periodicity and offset can be coordinated between neighboring gNBs regarding periodic or semi-static cell DTX/DRX. Non-Patent Literature 13 suggests that dynamic cell DTX/DRX patterns can be exchanged with neighboring gNBs either before the cell DTX/DRX inactivity period (provided that fast backhaul is available) or retroactively after the inactivity period is over.

### CITATION LIST

### Non Patent Literature

[Non-Patent Literature 1] 3GPP TS 38.300 V 17.4.0 (2023-03) “3rd Generation Partnership Project; Technical Specification Group Radio Access Network; NR; NR and NG-RAN Overall Description; Stage 2 (Release 17)”, March 2023
[Non-Patent Literature 2] 3GPP TS 38.321 V 17.4.0 (2023-03) “3rd Generation Partnership Project; Technical Specification Group Radio Access Network; NR; Medium Access Control (MAC) protocol specification (Release 17)”, March 2023
[Non-Patent Literature 3] 3GPP TS 38.331 V 17.4.0 (2023-03) “3rd Generation Partnership Project; Technical Specification Group Radio Access Network; NR; Radio Resource Control (RRC) protocol specification (Release 17)”, March 2023
[Non-Patent Literature 4] 3GPP TR 38.864 V 18.0.0 (2022-12) “3rd Generation Partnership Project; Technical Specification Group Radio Access Network; Study on network energy savings for NR (Release 18)”, January 2023
[Non-Patent Literature 5] ZTE, Sanechips, “Discussion on cell DTX/DRX”, R1-2300373, 3GPP TSG-RAN WG1 Meeting #112, Athens, Greece, Feb. 27-Mar. 3, 2023
[Non-Patent Literature 6] InterDigital, “Report of [301] [NES] Summary of DTX/DRX-8.3.2”, R2-2213071, 3GPP TSG-RAN WG2 Meeting #120, Toulouse, France, Nov. 14-19, 2022
[Non-Patent Literature 7] InterDigital, “Report of [301] [NES] Summary of DTX/DRX-8.3.2”, R2-2213075, 3GPP TSG-RAN WG2 Meeting #120, Toulouse, France, Nov. 14-19, 2022
[Non-Patent Literature 8] InterDigital, “Cell DTX/DRX mechanism”, R2-2300632, 3GPP TSG-RAN WG2 Meeting #121, Athens, Greece, Feb. 27-Mar. 3, 2023
[Non-Patent Literature 9] InterDigital, “NES cell selection and resection for NES”, R2-2300633, 3GPP TSG-RAN WG2 Meeting #121, Athens, Greece, Feb. 27-Mar. 3, 2023
[Non-Patent Literature 10] MediaTek Inc., “Further discussion on Cell DTX/DRX”, R2-2301854, 3GPP TSG-RAN WG2 Meeting #121, Athens, Greece, Feb. 27-Mar. 3, 2023
[Non-Patent Literature 11] Nokia, Nokia Shanghai Bell, “Further details on Cell DTX/DRX”, R2-2301515, 3GPP TSG-RAN WG2 Meeting #121, Athens, Greece, Feb. 27-Mar. 3, 2023
[Non-Patent Literature 12] Session Chair (InterDigital), “Report from Session on NES, UAV, Small Data, Rel-15-17 UP, Rel-17 Small Data, IIoT/URLLC, and RACH partitioning”, R2-2301903, 3GPP TSG-RAN WG2 Meeting #121, Athens, Greece, Feb. 27-Mar. 3, 2023
[Non-Patent Literature 13] Qualcomm Incorporated, “Information exchange over network interfaces for network energy savings”, R3-226525, 3GPP TSG-RAN WG3 Meeting #118, Toulouse, France, Nov. 14-18, 2022

### SUMMARY OF INVENTION

### Technical Problem

The inventor has studied cell DTX/DRX and identified a number of problems. Some of the problems identified by the inventors relate to the specifics of how the network configures the cell DTX/DRX duration to UEs. First, it is not clear in detail how the network configures the cell DTX/DRX ON duration to UEs. Second, it is not clear how to align cell DTX/DRX and UE CDRX with regard to the configuration of the cell DTX/DRX ON duration. Third, it may be desirable for the network to be able to dynamically specify or change the duration of the cell DTX/DRX ON duration, but it is not clear how this can be achieved.

Some other problems identified by the inventor relate to the exchange of cell DTX/DRX configurations between RAN nodes. First, the details of how to exchange cell DTX/DRX configurations, including cell DTX/DRX ON duration, between RAN nodes are not clear. Second, the purpose of RAN nodes using DTX/DRX configurations of neighboring cells received from other RAN nodes is unclear.

Yet other problems identified by the inventor relate to cell selection and reselection. Specifically, it is unclear how to enable a UE to consider the following in cell selection and cell reselection: cell DTX/DRX pattern, whether cell DTX/DRX is activated, or both.

One of the objectives to be achieved by the example embodiments disclosed herein is to provide apparatuses, methods, and programs that contribute to solving at least one of a plurality of problems, including the problems described above. It should be noted that this object is only one of the objectives to be achieved by the example embodiments disclosed herein. Other objectives or problems and novel features will become apparent from the following description and the accompanying drawings.

### Solution to Problem

In a first aspect, a radio access network node is configured to transmit configuration information for cell DTX or cell DRX to one or more radio terminals in a cell. The configuration information includes a first field or information element indicating a length of a cycle of the cell DTX or cell DRX. The configuration information further includes a second field or information element that explicitly or implicitly indicates how many segments the cycle is divided into, and a third field or information element that indicates a number of one or more segments that define an ON duration of the cell DTX or cell DRX within the cycle.

In a second aspect, a method performed by a radio access network node includes transmitting configuration information for cell DTX or cell DRX to one or more radio terminals in a cell. The configuration information includes a first field or information element indicating a length of a cycle of the cell DTX or cell DRX. The configuration information further includes a second field or information element that explicitly or implicitly indicates how many segments the cycle is divided into, and a third field or information element that indicates a number of one or more segments that define an ON duration of the cell DTX or cell DRX within the cycle.

In a third aspect, a radio terminal is configured to receive configuration information for cell DTX or cell DRX from a network. The configuration information includes a first field or information element indicating a length of a cycle of the cell DTX or cell DRX. The configuration information further includes a second field or information element that explicitly or implicitly indicates how many segments the cycle is divided into, and a third field or information element that indicates a number of one or more segments that define an ON duration of the cell DTX or cell DRX within the cycle.

In a fourth aspect, a method performed by a radio terminal includes receiving configuration information for cell DTX or cell DRX from a network. The configuration information includes a first field or information element indicating a length of a cycle of the cell DTX or cell DRX. The configuration information further includes a second field or information element that explicitly or implicitly indicates how many segments the cycle is divided into, and a third field or information element that indicates a number of one or more segments that define an ON duration of the cell DTX or cell DRX within the cycle.

In a fifth aspect, a radio access network node is configured to send configuration information for cell DTX or cell DRX of a cell managed by the radio access network node to another radio access network node. The configuration information includes a first field or information element indicating a length of a cycle of the cell DTX or cell DRX. The configuration information further includes a second field or information element that explicitly or implicitly indicates how many segments the cycle is divided into, and a third field or information element that indicates a number of one or more segments that define an ON duration of the cell DTX or cell DRX within the cycle.

In a sixth aspect, a method performed by a radio access network node includes sending configuration information for cell DTX or cell DRX of a cell managed by the radio access network node to another radio access network node. The configuration information includes a first field or information element indicating a length of a cycle of the cell DTX or cell DRX. The configuration information further includes a second field or information element that explicitly or implicitly indicates how many segments the cycle is divided into, and a third field or information element that indicates a number of one or more segments that define an ON duration of the cell DTX or cell DRX within the cycle.

In a seventh aspect, a radio terminal is configured to receive, from a network, CDRX configuration information indicating a length of a cycle of CDRX, a start offset of the CDRX, and a length of an ON duration timer of the CDRX. The radio terminal is configured to receive cell DTX or cell DRX configuration information related to cell DTX or cell DRX from the network. The radio terminal is configured to recognize a pattern of the cell DRX or cell DRX based on the CDRX configuration information and the cell DTX or cell DRX configuration information. Specifically, the radio terminal considers a length of a cycle of the cell DTX or cell DRX to be equal to the length of the cycle of the CDRX. The radio terminal considers a start offset of the cell DTX or cell DRX to be equal to the start offset of the CDRX. The radio terminal considers a time length of a segment for defining an ON duration of the cell DTX or cell DRX to be equal to the length of the ON duration timer of the CDRX. The radio terminal recognizes how many segments the cycle of the cell DTX or cell DRX is divided into based on a value obtained by dividing the length of the cycle of the cell DTX or cell DRX by the time length of the segment. The cell DTX or cell DRX configuration information indicates a number of one or more segments that define the ON duration of the cell DTX or cell DRX within the cycle of the cell DTX or cell DRX. The radio terminal understands that a number of segments indicated by the cell DTX or cell DRX configuration information, counting from a first segment located at the beginning of the cycle of the cell DTX or cell DRX, corresponds to the ON duration of the cell DTX or cell DRX.

In an eighth aspect, a method performed by a radio terminal includes: (a) receiving, from a network, CDRX configuration information indicating a length of a cycle of CDRX, a start offset of the CDRX, and a length of an ON duration timer of the CDRX; (b) receiving cell DTX or cell DRX configuration information related to cell DTX or cell DRX from the network; and (c) recognizing a pattern of the cell DRX or cell DRX based on the CDRX configuration information and the cell DTX or cell DRX configuration information. Specifically, the radio terminal considers a length of a cycle of the cell DTX or cell DRX to be equal to the length of the cycle of the CDRX. The radio terminal considers a start offset of the cell DTX or cell DRX to be equal to the start offset of the CDRX. The radio terminal considers a time length of a segment for defining an ON duration of the cell DTX or cell DRX to be equal to the length of the ON duration timer of the CDRX. The radio terminal recognizes how many segments the cycle of the cell DTX or cell DRX is divided into based on a value obtained by dividing the length of the cycle of the cell DTX or cell DRX by the time length of the segment. The cell DTX or cell DRX configuration information indicates a number of one or more segments that define the ON duration of the cell DTX or cell DRX within the cycle of the cell DTX or cell DRX. The radio terminal understands that a number of segments indicated by the cell DTX or cell DRX configuration information, counting from a first segment located at the beginning of the cycle of the cell DTX or cell DRX, corresponds to the ON duration of the cell DTX or cell DRX.

In a ninth aspect, a radio access network node is configured to transmit first configuration information indicating a length of a cycle of cell DTX or cell DRX to one or more radio terminals in a cell via RRC signaling. The radio access network node is configured to transmit second configuration information indicating an ON duration of the cell DTX or cell DRX within the cycle of the cell DTX or cell DRX to one or more radio terminals in the cell via Layer 1 or Layer 2 signaling.

In a tenth aspect, a method performed by a radio access network node includes (a) transmitting first configuration information indicating a length of a cycle of cell DTX or cell DRX to one or more radio terminals in a cell via RRC signaling; and (b) transmitting second configuration information indicating an ON duration of the cell DTX or cell DRX within the cycle of the cell DTX or cell DRX to one or more radio terminals in the cell via Layer 1 or Layer 2 signaling.

In an eleventh aspect, a radio terminal is configured to receive first configuration information indicating a length of a cycle of cell DTX or cell DRX from a network via RRC signaling. The radio terminal is configured to receive second configuration information indicating an ON duration of the cell DTX or cell DRX within the cycle of the cell DTX or cell DRX from the network via Layer 1 or Layer 2 signaling.

In a twelfth aspect, a method performed by a radio terminal includes: (a) receiving first configuration information indicating a length of a cycle of cell DTX or cell DRX from a network via RRC signaling; and (b) receiving second configuration information indicating an ON duration of the cell DTX or cell DRX within the cycle of the cell DTX or cell DRX from the network via Layer 1 or Layer 2 signaling.

In a thirteenth aspect, a radio terminal is configured to receive from a network, via broadcast in a cell, pattern information for cell DTX or cell DRX, or activation information indicating whether the cell DTX or cell DRX is activated, or both. The radio terminal is configured to perform one or both of cell selection and cell reselection using one or both of the pattern information and the activation information.

In a fourteenth aspect, a method performed by a radio terminal includes: (a) receiving from a network, via broadcast in a cell, pattern information for cell DTX or cell DRX, or activation information indicating whether the cell DTX or cell DRX is activated, or both; and (b) performing one or both of cell selection and cell reselection using one or both of the pattern information and the activation information.

In a fifteenth aspect, a radio access network node is configured to broadcast, in a first cell, information about a cell DTX or cell DRX pattern of a second cell.

In a sixteenth aspect, a method performed by a radio access network node includes broadcasting, in a first cell, information about a cell DTX or cell DRX pattern of a second cell.

In a seventeenth aspect, a radio terminal is configured to receive from a network, via broadcast in a first cell, information about a cell DTX or cell DRX pattern of a second cell.

In an eighteenth aspect, a method performed by a radio terminal includes receiving from a network, via broadcast in a first cell, information about a cell DTX or cell DRX pattern of a second cell.

In a nineteenth aspect, a program includes a set of instructions (software code) that, if loaded into a computer, causes the computer to perform the operations or methods of the radio access network node or radio terminal described in the above aspects.

### Advantageous Effects of Invention

According to the aspects described above, it is possible to provide apparatuses, methods, and programs that contribute to solving at least one of a plurality of problems, including the problems described above.

### BRIEF DESCRIPTION OF DRAWINGS

FIG. 1 is a diagram showing an example configuration of a radio communication system related to one or more example embodiments.

FIG. 2 is a diagram showing a CDRX cycle.

FIG. 3 is a diagram showing examples of a plurality of CDRX-related timers.

FIG. 4 is a diagram showing examples of a plurality of CDRX-related timers.

FIG. 5 is a diagram showing a cell DTX cycle.

FIG. 6 is a diagram showing a cell DRX cycle.

FIG. 7 is a diagram illustrating a method for configuring an ON duration of cell DTX/DRX according to an example embodiment.

FIG. 8 is a diagram showing an example of signaling between a UE and a RAN node related to one or more example embodiments.

FIG. 9 is a diagram showing an example of signaling between a UE and a RAN node related to one or more example embodiments.

FIG. 10 is a diagram showing an example of signaling between a UE and a RAN node related to one or more example embodiments.

FIG. 11 is a diagram showing an example of signaling between a UE and a RAN node related to one or more example embodiments.

FIG. 12 is a diagram showing an example of signaling between a UE and a RAN node related to one or more example embodiments.

FIG. 13 is a diagram showing an example of signaling between RAN nodes related to one or more example embodiments.

FIG. 14 is a diagram showing an example of signaling between RAN nodes related to one or more example embodiments.

FIG. 15 is an example of a format of a Served Cell Information NR information element related to one or more example embodiments.

FIG. 16 is a diagram showing an example of signaling between a UE and a RAN node related to one or more example embodiments.

FIG. 17 is a flowchart showing an example of an operation of a UE related to one or more example embodiments.

FIG. 18 is a diagram showing an example of signaling between a UE and a RAN node related to one or more example embodiments.

FIG. 19 is a block diagram showing an example configuration of a UE related to one or more example embodiments.

FIG. 20 is a block diagram showing an example configuration of a radio access network node related to one or more example embodiments.

### EXAMPLE EMBODIMENT

Specific example embodiments will be described hereinafter in detail with reference to the drawings. Identical or corresponding elements are designated by the same symbols throughout the drawings, and duplicate explanations are omitted where necessary for the sake of clarity.

The multiple example embodiments described below may be implemented independently or in any suitable combination. These multiple example embodiments have novel features that differ from one another. Accordingly, these multiple example embodiments contribute to achieving different objectives or solving different problems and contribute to achieving different advantages.

Each of the drawings or figures is merely an example to illustrate one or more example embodiments. Each figure may not be associated with only one particular example embodiment but may be associated with one or more other example embodiments. As will be appreciated by those of ordinary skill in the art, various features or steps described with respect to any one of the figures may be combined with features or steps illustrated in one or more other figures to produce, for example, example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The following example embodiments are primarily described in the context of the 3GPP fifth generation mobile communication system (5G system). However, these example embodiments may also be applied to other radio communication systems that support technologies similar to 3GPP cell DTX and cell DRX.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

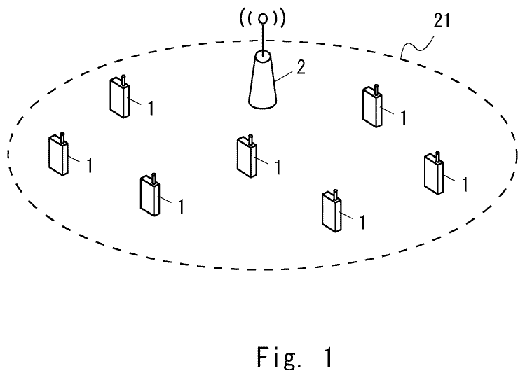

First, the configuration and operation of a plurality of network elements common to a plurality of example embodiments are described. FIG. 1 shows an example configuration of a radio communication system related to a plurality of example embodiments. Each element (or network function) shown in FIG. 1 can be implemented, for example, as a network element on dedicated hardware, as a software instance running on dedicated hardware, or as a virtualized function instantiated on an application platform.

In the example shown in FIG. 1, the radio communication system includes a plurality of UEs 1 and a radio access network (RAN) node 2. In the following, unless otherwise specified, the term “UE 1” refers to matters common to the plurality of UEs 1. The UE 1 may be referred to by other terms, such as a radio terminal, a mobile terminal, a mobile station, or a wireless transmit receive unit (WTRU). The RAN node 2 may be referred to by other terms, such as a network, a base station, or a radio station. The UE 1 has at least one radio transceiver and communicates with the RAN node 2. The RAN node 2 manages, operates, or provides a cell 21 and communicates with a plurality of UEs 1 within the cell 21 using cellular communication technology (i.e., NR Radio Access Technology). These communications include downlink and uplink transmissions. Downlink transmissions include the transmission of cell-specific synchronization signals, the transmission of cell-specific and UE-specific reference signals, the transmission of broadcast channels (e.g., Physical Broadcast Channel (PBCH)), the transmission of control channels (e.g., PDCCH), and the transmission of data transmission channels (e.g., Physical Downlink Shared Channel (PDSCH)). Uplink transmissions include the transmission of reference signals, the transmission of random access channels (i.e., Physical RACH (PRACH)), the transmission of control channels (e.g., PUCCH), and the transmission of data transmission channels (e.g., PUSCH).

The RAN node 2 may provide multiple cells including the cell 21, and the UE 1 may be connected to multiple cells provided by the RAN node 2 simultaneously. In other words, the UE 1 may perform carrier aggregation (CA) between multiple cells provided by the RAN node 2. Additionally, the UE 1 may be connected to the RAN node 2 and another RAN node simultaneously for dual connectivity (DC).

The RAN node 2 may be a Next Generation Radio Access Network (NG-RAN) node. An NG-RAN node may be a gNB or an ng-eNB. An ng-eNB is a node that provides Evolved Universal Mobile Telecommunications System (UMTS) Terrestrial Radio Access (E-UTRA) user plane and control plane protocol termination to UEs and is connected to a 5G Core Network (5GC) via an NG interface. The RAN node 2 may be a Central Unit (e.g., gNB-CU) in a cloud RAN (C-RAN) deployment, or a combination of a CU and one or more Distributed Units (e.g., gNB-DUs). C-RAN is also referred to as CU/DU split. Furthermore, the CU may include a Control Plane (CP) Unit (e.g., gNB-CU-CP) and one or more User Plane (UP) Units (e.g., gNB-CU-UP). Accordingly, the RAN node 2 may be a CU-CP or a combination of a CU-CP and a CU-UP. A CU may be a logical node that hosts the Radio Resource Control (RRC), Service Data Adaptation Protocol (SDAP), and Packet Data Convergence Protocol (PDCP) protocols of a gNB (or the RRC and PDCP protocols of a gNB). A DU may be a logical node that hosts the Radio Link Control (RLC), Medium Access Control (MAC), and Physical (PHY) layers of a gNB.

The UE 1 and the RAN node 2 support connected mode DRX (CDRX). If CDRX is configured, the UE 1 does not need to continuously monitor a PDCCH. CDRX is characterized by its on-duration, inactivity timer, retransmission timer, cycle, and active time. The on-duration is the duration that the UE 1 waits, after waking up, to receive PDCCHs. If the UE 1 successfully decodes a PDCCH, it stays awake and starts the inactivity timer. The inactivity timer is the duration that the UE 1 waits to successfully decode a next PDCCH from the last successful decoding of a PDCCH. If PDCCH decoding fails until the inactive timer expires, the UE 1 can return to sleep. The retransmission timer is the duration during which the UE 1 must be awake to receive retransmissions. The DRX cycle specifies a periodic repetition of the on-duration, followed by a period of possible inactivity. The active time is the total duration during which the UE 1 monitors a PDCCH. The active time includes the on-duration within a DRX cycle, the time during which the UE 1 performs continuous reception while the inactivity timer has not expired, and the time during which the UE 1 performs continuous reception while waiting for a retransmission opportunity.

CDRX is controlled by RRC. The CDRX-related parameters provided to the UE from the network by the RRC configuration (DRX-Config) include the following: drx-onDurationTimer, drx-SlotOffset, drx-Inactivity Timer, drx-Retransmission TimerDL (per Downlink (DL) HARQ process except for the broadcast process), drx-RetransmissionTimerUL (per Uplink (UL) HARQ process), drx-LongCycleStartOffset, drx-ShortCycle (optional), drx-ShortCycleTimer (optional), drx-HARQ-RTT-TimerDL (per DL HARQ process except for the broadcast process), and drx-HARQ-RTT-TimerUL (per UL HARQ process). Multiple serving cells of a MAC entity of the UE 1 may be configured by the RRC with two CDRX groups having different CDRX parameters. As described above, the term “CDRX group” is used in this description instead of the term “DRX group” used in the 3GPP specification. If two CDRX groups are configured, each serving cell is uniquely assigned to one of the two groups. The CDRX parameters that are configured individually for each CDRX group are drx onDuration Timer and drx-Inactivity Timer. On the other hand, the CDRX parameters common to the multiple CDRX groups are drx SlotOffset, drx-Retransmission TimerDL, drx-Retransmission TimerUL, drx-LongCycleStartOffset, drx-ShortCycle (optional), drx-ShortCycle Timer (optional), drx-HARQ-RTT-TimerDL, and drx-HARQ-RTT-TimerUL.

The drx-onDuration Timer is a timer that measures the CDRX on-duration. The drx-onDuration Timer specifies the duration for decoding PDCCH at the beginning of each DRX cycle (DRX ON) before entering power saving mode (CDRX OFF).

The drx-SlotOffset specifies the delay time before starting the drx-onDurationTimer. In other words, the drx-SlotOffset defines the start of the CDRX on-duration (or drx-onDuration Timer) based on the start of a subframe.

The drx-Inactivity Timer defines the duration after a PDCCH occasion that indicates a new uplink UL, downlink, or sidelink transmission for the MAC entity. In other words, the drx-Inactivity Timer indicates the duration that the UE 1 waits to successfully decode a (next) PDCCH from the last successful decoding of a PDCCH.

The drx-RetransmissionTimerDL indicates the maximum duration until a downlink retransmission is received. In other words, the drx-Retransmission TimerDL indicates the duration during which the UE 1 shall be awake to receive a downlink retransmission.

The drx-RetransmissionTimerUL indicates the maximum duration until a grant (uplink grant) for uplink retransmission is received. In other words, the drx-RetransmissionTimerUL indicates the duration during which the UE 1 shall be awake to receive a grant for uplink retransmission.

The drx-Long CycleStartOffset indicates the long DRX cycle (drx-LongCycle) and the start offset (drx-StartOffset). The drx-StartOffset defines the subframe where the long DRX cycle and short DRX cycle start.

The drx-ShortCycle (optional) Indicates the Short DRX cycle.

The drx-ShortCycleTimer (optional) indicates the duration for which the UE 1 follows the short DRX cycle. The drx-ShortCycleTimer indicates the timer value as a multiple of the short DRX cycle (drx-ShortCycle), and the timer value can be 1 to 16, i.e., 1 to 16 short DRX cycles.

The drx-HARQ-RTT-TimerDL indicates the minimum duration or interval before a DL assignment for HARQ retransmission is expected by the MAC entity. In other words, the drx-HARQ-RTT-TimerDL defines the minimum amount of time before the UE 1 can expect a downlink retransmission after sending a hybrid automatic repeat request (HARQ) negative acknowledge (NACK) in the uplink.

The drx-HARQ-RTT-TimerUL indicates the minimum duration or interval before a grant for uplink retransmission is expected by the MAC entity. In other words, the drx-HARQ-RTT-TimerUL defines the minimum amount of time before the UE 1 can expect to receive a downlink grant for retransmission after performing a PUSCH transmission.

If CDRX is configured, the active time for multiple serving cells in a CDRX group includes, among other time periods, the time while:
the drx-onDuration Timer or drx-Inactivity Timer configured for the CDRX group is running; or
the drx-RetransmissionTimerDL or drx-RetransmissionTimerUL is running on any of the serving cells in the CDRX group; or
a scheduling request is sent on a PUCCH and is pending; or
a PDCCH indicating a new transmission to the C-RNTI of the MAC entity has not been received after successful reception of a random access response to a random access preamble not selected by the MAC entity.

The network, specifically the RAN node 2, provides the UE 1 with an RRC configuration (i.e., DRX-Config) related to CDRX by using a UE-specific (or dedicated) RRC message, specifically an RRCReconfiguration message. The DRX-Config is contained in a MAC-CellGroupConfig within a CellGroupConfig carried by an RRCReconfiguration message.

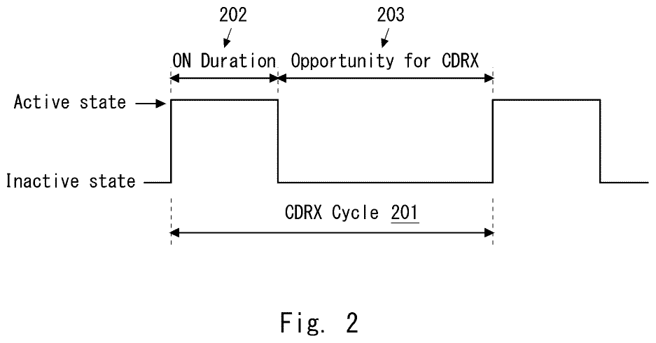

FIG. 2 shows an example of a CDRX cycle. As shown in FIG. 2, one CDRX cycle 201 includes an ON duration 202 at the beginning of the cycle. The ON duration 202 is one of the CDRX active times of the UE 1. After the ON duration 202, there is a CDRX opportunity 203. During the CDRX opportunity 203, the UE 1 can enter sleep mode if neither the inactivity timer (drx-Inactivity Timer) nor the retransmission timers (drx-Retransmission TimerDL, drx-Retransmission TimerUL) are running.

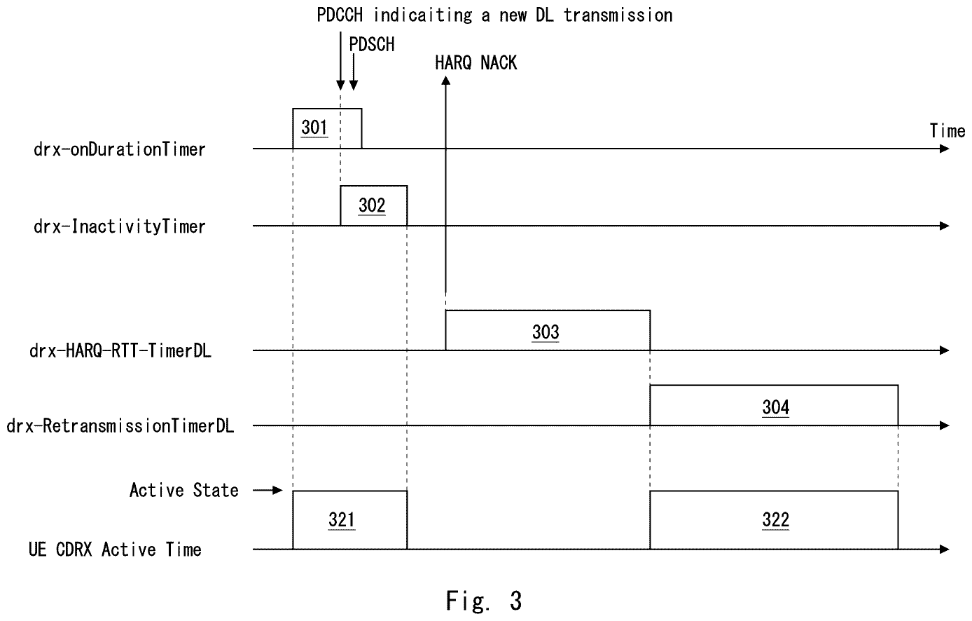

FIG. 3 is a diagram showing the relationship between multiple CDRX-related timers and the CDRX active time with respect to downlink reception by the UE 1. If the UE 1 receives a PDCCH indicating a new downlink (DL) transmission while the on-duration timer (drx-onDurationTimer) 301 is running, the UE 1 starts or restarts the inactivity timer (drx-Inactivity Timer) 302. The MAC entity of the UE 1 starts or restarts the inactivity timer (drx-Inactivity Timer) 302 at the first symbol after PDCCH reception ends. If the UE 1 fails in PDSCH reception, the UE 1 transmits a HARQ NACK and starts the HARQ round trip time (RTT) timer (drx-HARQ-RTT-TimerDL) 303 for the corresponding HARQ process. The MAC entity of the UE 1 starts the HARQ RTT timer (drx-HARQ-RTT-TimerDL) 303 for the corresponding HARQ process in the first symbol after the end of the transmission carrying the HARQ feedback (NACK). After the HARQ RTT timer (drx-HARQ-RTT-TimerDL) 303 expires, the UE 1 immediately starts the retransmission timer (drx-Retransmission TimerDL) 304 for the corresponding HARQ process. The MAC entity of the UE 1 starts the retransmission timer (drx RetransmissionTimerDL) 304 at the first symbol after the expiration of the HARQ RTT timer (drx-HARQ-RTT-TimerDL) 303. In the example shown in FIG. 3, the CDRX active time includes the time period 321 during which the on-duration timer (drx-onDurationTimer) 301 and the inactivity timer (drx-Inactivity Timer) 302 are running, and the time period 322 during which the retransmission timer (drx-RetransmissionTimerDL) 304 is running. During the CDRX active time, the UE 1 is required to monitor a PDCCH.

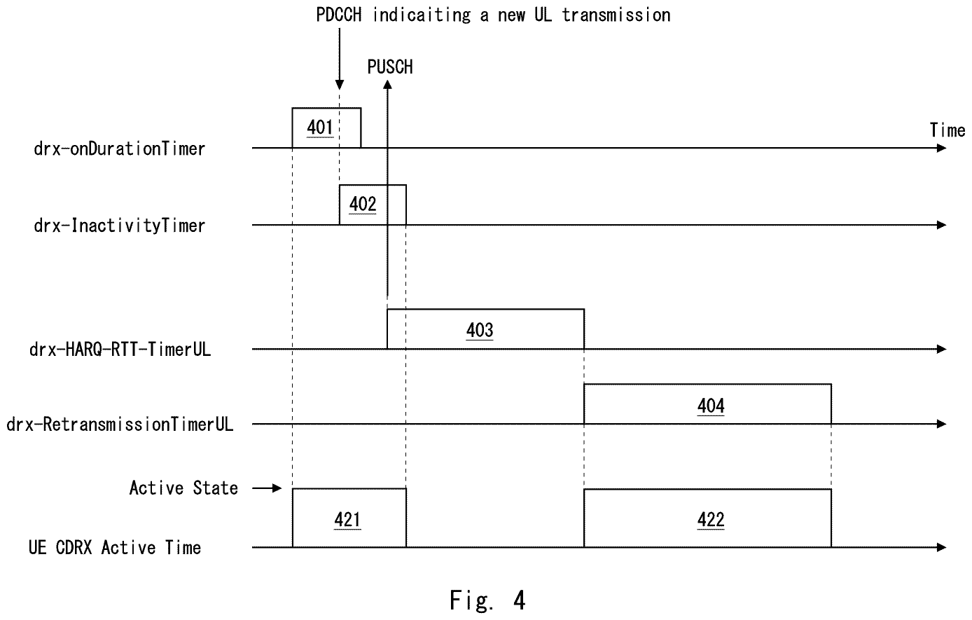

FIG. 4 is a diagram showing the relationship between multiple CDRX-related timers and the CDRX active time with respect to uplink transmission of the UE 1. If the UE 1 receives a PDCCH indicating a grant for a new uplink (UL) transmission while the on-duration timer (drx-onDuration Timer) 401 is running, the UE 1 starts or restarts the inactivity timer (drx-Inactivity Timer) 402. The MAC entity of the UE 1 starts or restarts the inactivity timer (drx-Inactivity Timer) 402 at the first symbol after PDCCH reception ends. After the PUSCH transmission, the UE 1 starts the HARQ RTT timer (drx-HARQ-RTT-TimerUL) 403 for the corresponding HARQ process. The MAC entity of the UE 1 starts the HARQ RTT timer (drx-HARQ-RTT-TimerUL) 403 at the first symbol after the end of the first transmission of the PUSCH transmission. After the HARQ RTT timer (drx-HARQ-RTT-TimerUL) 403 expires, the UE 1 immediately starts the retransmission timer (drx-RetransmissionTimerUL) 404 for the corresponding HARQ process. The MAC entity of the UE 1 starts the retransmission timer (drx-RetransmissionTimerUL) 404 at the first symbol after the expiration of the HARQ RTT timer (drx-HARQ-RTT-TimerUL) 403. In the example shown in FIG. 4, the CDRX active time includes the time period 421 during which the on-duration timer (drx-onDuration Timer) 401 and the inactivity timer (drx-Inactivity Timer) 402 are running, and the time period 422 during which the retransmission timer (drx-Retransmission TimerUL) 404 is running. During the CDRX active time, the UE 1 is required to monitor a PDCCH.

Furthermore, the UE 1 and the RAN node 2 support cell DTX and cell DRX. As described above, in the present description, the terms “cell DTX ON duration,” “cell DTX off duration,” “cell DRX ON duration,” and “cell DRX off duration” are used with respect to cell DTX/DRX. The cell DTX/DRX ON duration refers to the duration, time, or period during which a cell is active and can transmit and receive all necessary cell common channels and signals, as well as UE-specific signals and channels. In contrast, the cell DTX/DRX off duration refers to the duration, time, or period during which the cell is in an inactive state for NES and does not transmit or receive, or is allowed to maintain only restricted transmission or reception. The cell DTX/DRX ON duration may also be referred to as the cell DTX/DRX ON time or period, or the cell DTX/DRX active time, period, or duration. The cell DTX/DRX off duration may also be referred to as the cell DTX/DRX off time or off period, or the cell DTX/DRX inactive (or non-active) time, period, or duration.

If the cell DTX of the cell 21 is activated, the RAN node 2 may not perform downlink transmission in the cell 21 during the off duration of the cell DTX, or may maintain only restricted downlink transmission. Similarly, if the cell DRX of the cell 21 is activated, the RAN node 2 may not perform uplink reception in the cell 21 during the off duration of the cell DRX, or may maintain only restricted uplink reception. In the first example, during the cell DTX/DRX off duration, the RAN node 2 is expected to turn off all transmission or reception of data traffic and reference signals in the cell 21. In the second example, during the cell DTX/DRX off duration, the RAN node 2 is expected to turn off only the transmission or reception of data traffic in the cell 21. That is, the RAN node 2 continues to transmit or receive reference signals. In the third example, during the cell DTX/DRX off duration, the RAN node 2 is expected to turn off dynamic data transmission or reception in the cell 21. That is, the RAN node 2 is expected to continue to transmit or receive on periodic resources such as SPS, CG PUSCH, SR, RACH, and SRS. In the fourth example, during the cell DTX off duration, the RAN node 2 is expected to transmit only reference signals (e.g., CSI-RS for measurement) in the cell 21.

Cell DTX mode and cell DRX mode can be configured and operated separately (e.g., one RRC configuration set for downlink and another RRC configuration set for uplink). Cell DTX and cell DRX can also be configured and operated together. For each cell DTX/DRX configuration, parameters including at least periodicity or cycle, start offset, and ON duration can be configured. The RAN node 2 may provide the cell DTX/DRX configuration information to the UE 1 via cell-specific (or cell-common) or UE-specific RRC signaling. The cell-specific RRC signaling may be system information (e.g., SIB). The UE-specific RRC signaling may be an RRC Reconfiguration message. If system information is used to send the cell DTX/DRX configuration information, the cell DTX/DRX configuration information can be updated using a system information modification procedure.

Cell DTX and cell DRX may be activated or deactivated separately or together. Cell DTX/DRX activation may be performed using Layer 1, Layer 2, or Layer 3 (L1/L2/L3) signaling. The RAN node 2 may transmit L1/L2/L3 signaling indicating cell DTX/DRX activation. This indication may be referred to as NES mode indication, NES activation indication, etc. The L1/L2/L3 signaling may be UE-specific, UE group-specific, or cell-specific (i.e., cell common).

UE-specific L1 signaling may be a DCI format with Cyclic Redundancy Check (CRC) bits scrambled by a UE-specific RNTI (e. g., C-RNTI). In other words, UE-specific L1 signaling may be a PDCCH that carries CRC bits scrambled by a UE-specific RNTI.

UE group-specific L1 signaling may be a DCI format with CRC bits scrambled by a UE group-specific RNTI. In other words, UE group-specific L1 signaling may be a PDCCH carrying CRC bits scrambled by a UE group-specific RNTI. The UE group may only include NES-capable UEs in the cell 21, excluding NES-incompatible legacy UEs. The UE group-specific RNTI may be a newly defined RNTI for cell DTX/DRX.

Cell-specific L1 signaling may be a DCI format with CRC bits scrambled by a cell-specific RNTI. In other words, cell-specific L1 signaling may be a PDCCH that carries CRC bits scrambled by a cell-specific RNTI. The cell-specific or cell-common RNTI may be a System Information RNTI (SI-RNTI) or a Paging RNTI (P-RNTI), or it may be an RNTI newly defined for cell DTX/DRX. Specifically, cell-specific L1 signaling may be a DCI containing a short message indicating a change in system information, or a PDCCH carrying the DCI with CRC bits scrambled by a P-RNTI. The DCI may indicate a short message indicating activation of cell DTX/DRX or NES mode in addition to a short message indicating a change in system information.

UE-specific L2 signaling may be a MAC CE transmitted in a PDSCH that is scheduled by a DCI format with CRC bits scrambled by a UE-specific RNTI. UE group-specific L2 signaling may be a MAC CE transmitted in a PDSCH scheduled by a DCI format with CRC bits scrambled by a UE group-specific RNTI. Cell-specific L2 signaling may be a MAC CE transmitted in a PDSCH scheduled by a DCI format with CRC bits scrambled by a cell-specific RNTI.

Cell-specific L3 signaling may be system information (e.g., SIB). UE-specific L3 signaling may be a UE-dedicated RRC message, specifically an RRC Reconfiguration message.

The cell DTX/DRX ON duration may be extended. The cell DTX ON duration and the cell DRX ON duration may be extended separately or together. If the RAN node 2 wants to extend the cell DTX ON duration or the cell DRX ON duration or both, it may send L1/L2 signaling to the UE 1 to trigger the extension of the ON duration. This L1/L2 signaling may be cell-specific (or cell-common), UE group-specific, or UE-specific. Specific examples of L1/L2 signaling for extending the cell DTX/DRX ON duration are the same as those described for L1/L2 signaling for activating cell DTX/DRX. Extension of the cell DTX/DRX ON duration within a cell DTX/DRX cycle is accompanied by a reduction of the cell DTX/DRX OFF duration within that cycle.

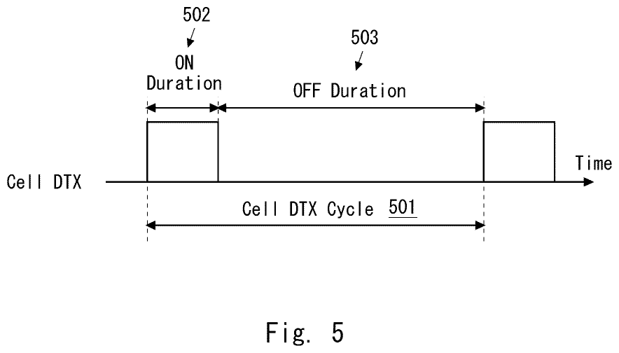

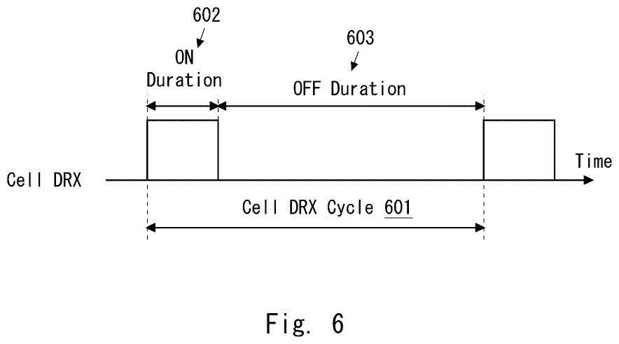

FIG. 5 shows an example of a cell DTX cycle. In the example shown in FIG. 5, a single cell DTX cycle 501 includes the ON duration 502 at the beginning of the cycle. The ON duration 502 is followed by the OFF duration 503. FIG. 6 shows an example of a cell DRX cycle. In the example of FIG. 6, a single cell DRX cycle 601 includes the ON duration 602 at the beginning of the cycle. The ON duration 602 is followed by the OFF duration 603.

The RAN node 2 may align the cell DTX with the UE CDRX configured for UEs 1 in the cell 21, specifically NES-capable UEs that support cell DTX/DRX. Specifically, the RAN node 2 may adjust the CDRX ON duration of each NES-capable UE in the cell 21 so that it is included in the cell DTX ON duration of the cell 21.

More specifically, the RAN node 2 may adjust the length of the long CDRX cycle configured for each NES-capable UE in the cell 21 so that it is equal to, or approximately equal to, the length of the cell DTX cycle. Additionally, the RAN node 2 may set the cell DTX ON duration to be sufficiently longer than the ON duration of the long CDRX cycle configured for each NES-capable UE. Furthermore, the RAN node 2 may appropriately adjust the start offset of the long CDRX cycle configured for each NES-capable UE with respect to the start offset of the cell DTX cycle so that the ON duration of the long CDRX cycle of each NES-capable UE in the cell 21 is located near the beginning of the cell DTX ON duration in the cell 21. These contribute to increasing the probability that the CDRX active time, which can be extended by the operation of the CDRX inactive timer and the uplink and downlink retransmission timers, falls within the cell DTX ON duration.

### FIRST EXAMPLE EMBODIMENT

An example configuration of a radio communication system according to the present example embodiment is the same as the example configuration described with reference to FIG. 1. The present example embodiment provides details on how to configure the ON duration of cell DTX/DRX.

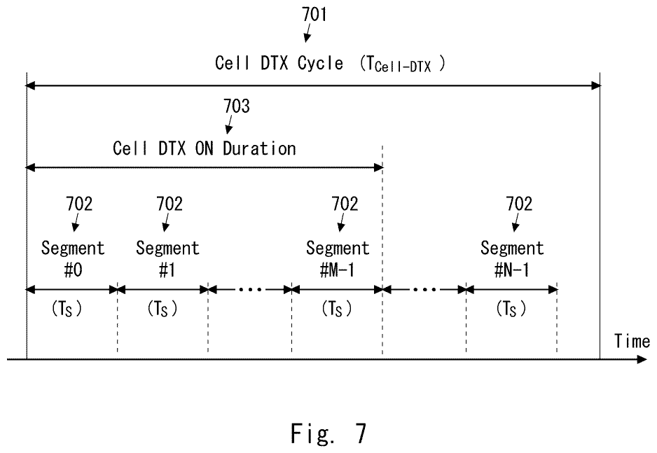

FIG. 7 is a diagram explaining how to configure the cell DTX ON duration. A cell DTX cycle 701 includes one or more segments (or sections) 702. In other words, the cell DTX cycle 701 is divided into one or more segments 702. In the example shown in FIG. 7, the total number of segments is N. N is an integer greater than or equal to 1. The time lengths T_{S} of the N segments are all equal. The total time length (N×T_{S}) of the N segments is equal to or less than the length T_{Cell-DTX} of the cell DTX cycle 701. Of the N segments, M segments, counting from the first segment #0 located at the beginning of the cell DTX cycle 701, are designated as the cell DTX ON duration 703. M is an integer greater than or equal to 1 and less than or equal to N. The remaining time in the cell DTX cycle 701 after the N segments is included in the cell DTX/DRX OFF duration. The ON duration of cell DRX can be configured similarly, as shown in FIG. 7.

The length of the cell DTX/DRX cycle 701 may be specified in milliseconds, slots, subframes, or radio frames. In this case, the time length of each segment may be equal to or greater than two milliseconds, two slots, two subframes, or two radio frames. In 5G NR, the length of a subframe is 1 millisecond, and the length of a radio frame is 10 milliseconds or 10 subframes. In 5G NR, a slot is a scheduling unit consisting of 14 Orthogonal Frequency Division Multiplexing (OFDM) symbols. The number of slots within a subframe (i.e., 1 ms) varies depending on numerology (particularly, subcarrier spacing).

The length of cell DTX/DRX cycle 701 may be specified in units of subframes. In this case, the time length of each segment may be specified in units of slots.

The length of the cell DTX/DRX cycle 701 may be specified in units of radio frames. In this case, the time length of each segment may be specified in units of subframes or slots.

If the configuration method shown in FIG. 7 is adopted, the RAN node 2 explicitly or implicitly notifies the UE 1 of the number of segments into which the cell DTX/DRX cycle is divided, and notifies the UE 1 of the number of one or more segments that define the ON duration within the cell DTX/DRX cycle. The RAN node 2 may send cell DTX/DRX configuration information, including these configurations or indications, to the UE 1 via one L1/L2/L3 signaling or via multiple separate L1/L2/L3 signalings.

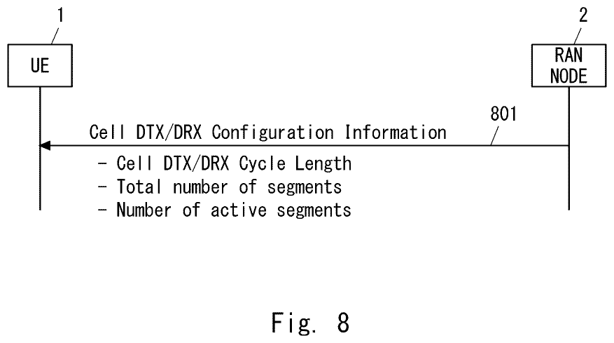

In an example, as shown in FIG. 8, the RAN node 2 transmits cell DTX/DRX configuration information 801 to one or more UEs 1 in the cell 21. The cell DTX/DRX configuration information 801 indicates the length of the cell DTX/DRX cycle (i.e., the value of T_{Cell-DTX} in the example shown in FIG. 7), the total number of segments (i.e., the value of N in the example in FIG. 7), and the number of active segments corresponding to the cell DTX/DRX ON duration (i.e., the value of M in the example in FIG. 7). Specifically, the cell DTX/DRX configuration information 801 includes first to third fields or information elements. The first field or information element indicates the length of the cell DTX/DRX cycle (i.e., T_{Cell-DTX}). The second field or information element indicates the total number of segments (i.e., N). The third field or information element indicates the number of active segments (i.e., M). The second field or information element indicates a dimensionless number that explicitly represents the total number of segments within the cell DTX/DRX cycle. In this example, the UE 1 understands that the time length of one segment (i.e., T_{S}) is equal to the largest integer that does not exceed the real number obtained by dividing the length of the cell DTX/DRX cycle (i.e., T_{Cell-DTX}) by the total number of segments (i.e., N). The UE 1 understands that the number of segments indicated by the third field or information element, counting from the first segment located at the beginning of the cell DTX/DRX cycle, corresponds to the cell DTX/DRX ON duration. The UE 1 may understand that the remaining (N-M) segments are included in the cell DTX/DRX OFF duration. Additionally, the UE 1 may understand that the remaining time in the cell DTX/DRX cycle after the N segments is included in the cell DTX/DRX OFF duration.

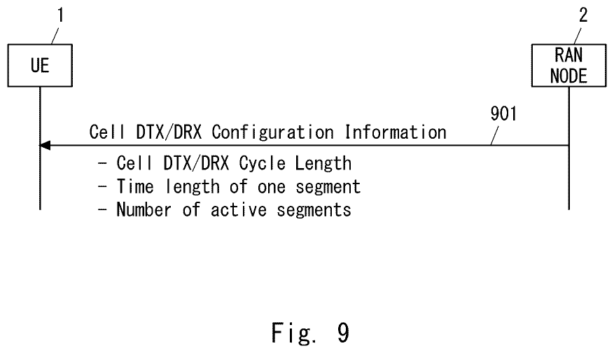

In another example, as shown in FIG. 9, the RAN node 2 transmits cell DTX/DRX configuration information 901 to one or more UEs 1 in the cell 21. The cell DTX/DRX configuration information 901 indicates the length of the cell DTX/DRX cycle (i.e., the value of T_{Cell-DTX} in the example shown in FIG. 7), the time length of one segment (i.e., the value of Ts in the example in FIG. 7), and the number of active segments corresponding to the cell DTX/DRX ON duration (i.e., the number M in the example in FIG. 7). Specifically, the cell DTX/DRX configuration information 901 includes first to third fields or information elements. The first field or information element indicates the length of the cell DTX/DRX cycle (i.e., T_{Cell-DTX}). The second field or information element indicates the time length of one segment (i.e., T_{S}). The third field or information element indicates the number of active segments (i.e., M). In other words, in the example shown in FIG. 9, the RAN node 2 does not need to explicitly notify the UE 1 of the total number of segments (i.e., the value of N in the example shown in FIG. 7). The second field or information element, which indicates the time length of one segment, can implicitly indicate to the UE 1 how many segments the DTX/DRX cycle is divided into, based on the value obtained by dividing the length of the cell DTX/DRX cycle by the time length of the segment. The UE 1 may understand that the largest integer that does not exceed the real number obtained by dividing the cell DTX/DRX cycle length (i.e., T_{Cell-DTX}) by the segment time length (i.e., T_{S}) is equal to the total number of segments (i.e., N). The UE 1 understands that the number of segments indicated by the third field or information element, counting from the first segment located at the beginning of the cell DTX/DRX cycle, corresponds to the ON duration. The UE 1 may understand that the remaining (N-M) segments are included in the cell DTX/DRX OFF duration. Additionally, the UE 1 may understand that the remaining time in the cell DTX/DRX cycle after the N segments is included in the cell DTX/DRX OFF duration.

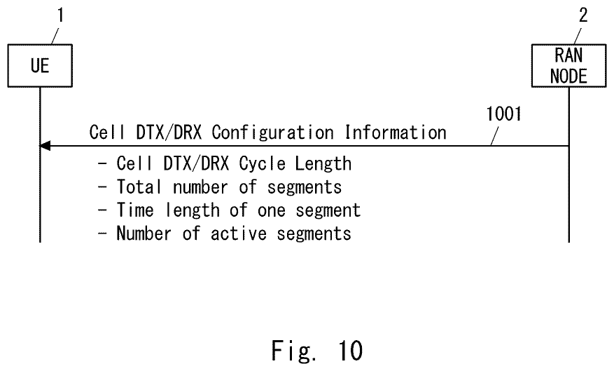

In yet another example, as shown in FIG. 10, the RAN node 2 transmits cell DTX/DRX configuration information 1001 to one or more UEs 1 in the cell 21. The cell DTX/DRX configuration information 1001 indicates the length of the cell DTX/DRX cycle (i.e., the value of T_{Cell-DTX} in the example shown in FIG. 7), the total number of segments (i.e., the value of N in the example in FIG. 7), the duration of one segment (i.e., the value of T_{S} in the example in FIG. 7), and the number of active segments corresponding to the cell DTX/DRX ON duration (i.e., the number M in the example in FIG. 7). Specifically, the cell DTX/DRX configuration information 1001 includes first to third fields or information elements. The first field or information element indicates the length of the cell DTX/DRX cycle (i.e., T_{Cell-DTX}). The second field or information element indicates both the total number of segments (i.e., N) and the time length of one segment (i.e., T_{S}). The third field or information element indicates the number of active segments (i.e., M). As in the examples shown in FIG. 8 and FIG. 9, the UE 1 understands that the number of segments indicated by the third field or information element, counting from the first segment located at the beginning of the cell DTX/DRX cycle, corresponds to the ON duration. The UE 1 may understand that the remaining (N-M) segments are included in the cell DTX/DRX OFF duration. Additionally, the UE 1 may understand that the remaining time in the cell DTX/DRX cycle after the N segments is included in the cell DTX/DRX OFF duration.

As can be understood from the description with reference to FIGS. 7 to 10, the present embodiment provides a specific method by which a network (e.g., RAN node 2) can configure the cell DTX/DRX ON duration to the UE 1. The following provides further details of the present embodiment.

The cell DTX/DRX configuration information 801, 901, and 1001 may further indicate other information. In other words, the cell DTX/DRX configuration information 801, 901, and 1001 may include additional fields or information elements separate from the fields or information elements described above. Specifically, the cell DTX/DRX configuration information 801, 901, and 1001 may indicate the start offset of the cell DTX/DRX cycle.

The RAN node 2 may broadcast the cell DTX/DRX configuration information 801, 901, or 1001 via cell-specific (or cell-common) RRC signaling in the cell 21. The cell-specific (or cell-common) RRC signaling may be system information, specifically the Master Information Block (MIB) or a SIB. In this case, the cell DTX/DRX configuration information 801, 901, and 1001 may indicate whether or not cell DTX or cell DRX is activated in the cell 21. For example, the broadcast of the cell DTX configuration information in the cell 21 may implicitly indicate that cell DTX is activated in the cell 21. If information about the cell DTX/DRX pattern indicates a specific value, for example, if the total number of segments (i.e., N) is set to zero, the UE 1 may understand that cell DTX/DRX is deactivated in the cell 21.

The cell DTX/DRX configuration information 801, 901, and 1001 may be used by one or more UEs 1 for cell selection or cell reselection. The UE 1 may receive the cell DTX/DRX configuration information 801, 901, or 1001 broadcast in a cell and perform cell selection, cell reselection, or both, based on the information. For example, if the UE 1 wishes to use a latency-critical service, it may select a cell in which cell DTX or cell DRX is deactivated in preference to a cell in which cell DTX or cell DRX is activated, in cell selection or cell reselection or both. With these implementations, the UE 1 can consider information about the pattern or activation of cell DTX/DRX for NES during cell selection or reselection.

The cell DTX/DRX configuration information 801, 901, or 1001 may be used by one or more UEs 1 to perform cell measurements of the cell 21 for cell selection, cell reselection, or mobility (e.g., handover or conditional handover) during the cell DTX ON duration of the cell 21. The UE 1 may recognize the cell DTX pattern of the cell 21 based on the cell DRX configuration information 801, 901, or 1001. The UE 1 may then perform cell measurements of the cell 21 during the cell DTX ON duration of the cell 21 for cell selection, cell reselection, or mobility. With these implementations, the UE 1 can consider information about the pattern or activation of cell DTX/DRX for NES for cell measurements.

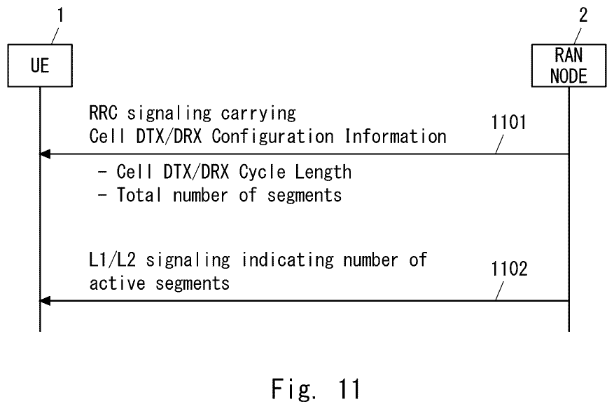

The RAN node 2 may send the cell DTX/DRX configuration information 801, 901, or 1001 to the UE 1 via multiple separate L1/L2/L3 signalings. For example, as shown in FIG. 11, the RAN node 2 transmits a first field or information element indicating the length of the cell DTX/DRX cycle (i.e., T_{Cell-DTX}) and a second field or information element indicating the total number of segments (i.e., N) via cell-specific or UE-specific RRC signaling (Step 1101). In step 1101, the second field or information element may indicate the time length of one segment (i.e., T_{S}) instead of or in addition to the total number of segments (i.e., N). The RAN node 2 may transmit a third field or information element indicating the number of active segments (i.e., M) via cell-specific, UE group-specific, or UE-specific L1/L2 signaling (step 1102), which is more dynamic than the RRC signaling.

According to the operation shown in FIG. 11, the RAN node 2 can dynamically specify or change the number of active segments (i.e., M), i.e., the time length of the cell DTX/DRX ON duration. For example, the RAN node 2 may dynamically increase or decrease the number of active segments (i.e., M) according to the traffic condition of the cell 21 or the number of UEs that are active (or in connected mode) in the cell 21. The L1/L2 signaling in step 1102 may be signaling for activating cell DTX/DRX. In other words, the L1/L2 signaling in step 1102 may indicate the activation of cell DTX/DRX and specify the ON duration of the cell DTX/DRX to be activated.

Specific examples of the L1/L2 signaling in step 1102 are the same as those described above with respect to the L1/L2 signaling for activating cell DTX/DRX. Specifically, in step 1102, UE-specific, UE group-specific, or cell-specific LI signaling may be a DCI format with CRC bits scrambled by a UE-specific, UE group-specific, or cell-specific RNTI, or a PDCCH carrying this DCI format. UE-specific, UE group-specific, or cell-specific L2 signaling may be a MAC CE transmitted on a PDSCH scheduled by a DCI format with CRC bits scrambled by a UE-specific, UE group-specific, or cell-specific RNTI.

### SECOND EXAMPLE EMBODIMENT

An example configuration of a radio communication system according to the present example embodiment is the same as the example configuration described with reference to FIG. 1. The present embodiment provides a variation of the methods for configuring the cell DTX/DRX ON duration described in the first example embodiment.

This example embodiment adopts the cell DTX/DRX ON duration configuration method shown in FIG. 7. The RAN node 2 reuses a CDRX configuration to notify the UE 1 of the cell DTX/DRX pattern configuration shown in FIG. 7. Specifically, the UE 1 considers the length of the cell DTX/DRX cycle (i.e., T_{Cell-DTX}) to be equal to the length of the UE CDRX cycle, specifically the long DRX cycle. Additionally, the UE 1 considers the start offset of the cell DTX/DRX cycle to be equal to the start offset of the UE CDRX cycle. Furthermore, the UE 1 considers the time length of the segment (i.e., T_{S}) for defining the ON duration within the cell DTX/DRX cycle to be equal to the length of the UE CDRX ON duration timer. The UE 1 may understand that the maximum integer that does not exceed the real number obtained by dividing the cell DTX/DRX cycle length (i.e., TCell-DTX) by the segment time length (i.e., TS) is equal to the total number of segments (i.e., N). Consequently, in order to notify the UE 1 of the cell DTX/DRX pattern, the RAN node 2 only needs to transmit the cell DTX/DRX configuration information indicating the number of active segments (i.e., M) to the UE 1 separately from the CDRX configuration. The UE 1 understands that the number of segments indicated by the cell DTX/DRX configuration information, counting from the first segment located at the beginning of the cell DTX/DRX cycle, corresponds to the cell DTX/DRX ON duration. This reduces the signaling overhead for transmitting the cell DTX/DRX configuration to the UE 1 compared to using a cell DTX/DRX configuration that is completely independent and separate from the CDRX configuration.

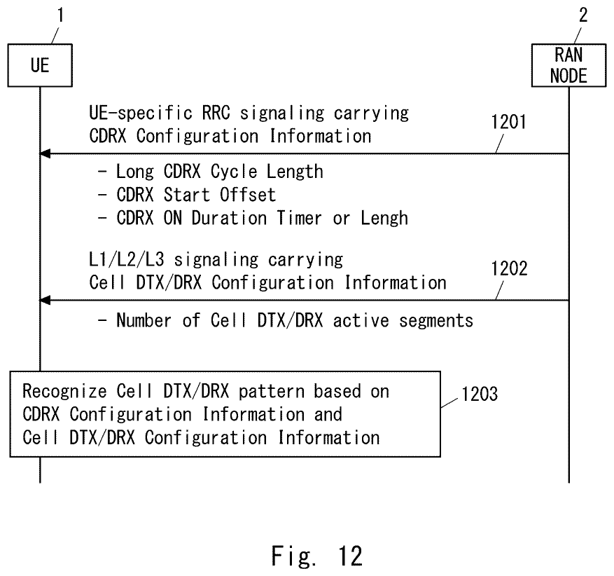

FIG. 12 shows an example of signaling between the UE 1 and the RAN node 2. In step 1201, the UE 1 receives CDRX configuration information from the RAN node 2. The RAN node 2 may transmit the CDRX configuration information to the UE 1 via UE-specific RRC signaling. The CDRX configuration information in step 1201 indicates the length of the long CDRX cycle (drx-LongCycle), the CDRX start offset (drx-StartOffset), and the length of the CDRX ON duration timer (drx-onDuration Timer).

In step 1202, the UE 1 receives cell DTX/DRX configuration information from the RAN node 2. The RAN node 2 may transmit the cell DTX/DRX configuration information to the UE 1 via cell-specific, UE group-specific, or UE-specific Layer 1, Layer 2, or Layer 3 (L1/L2/L3) signaling. The cell DTX/DRX configuration information in step 1202 indicates the number (i.e., M) of one or more segments that define the cell DTX/DRX ON duration within the cell DTX/DRX cycle. The order of steps 1201 and 1202 is not limited. Steps 1201 and 1202 may be performed substantially simultaneously, or step 1202 may be performed before step 1201.

In step 1203, the UE 1 recognizes the cell DTX/DRX pattern based on the CDRX configuration information (step 1201) and the cell DTX/DRX configuration information (step 1202). The operation of UE1 in step 1203 is as described a few paragraphs earlier.

In step 1202, cell-specific or UE-specific L3 signaling, specifically RRC signaling, may be used to convey the cell DTX/DRX configuration information. Cell-specific L3 signaling may be system information (e.g., SIB). UE-specific L3 signaling may be a UE-dedicated RRC message, specifically an RRC Reconfiguration message.

Alternatively, in step 1202, cell-specific, UE group-specific, or UE-specific L1/L2 signaling may be used to carry the cell DTX/DRX configuration information. This allows the RAN node 2 to dynamically specify or change the number of active segments (i.e., M), i.e., the time duration of the cell DTX/DRX ON duration. For example, the RAN node 2 may dynamically increase or decrease the number of active segments (i.e., M) depending on the traffic condition of the cell 21 or the number of UEs that are active (or in connected mode) in the cell 21. The L1/L2 signaling may be signaling for activating cell DTX/DRX. In other words, the L1/L2 signaling in step 1202 may indicate activation of cell DTX/DRX and specify the ON duration of the cell DTX/DRX to be activated.

Specific examples of the L1/L2 signaling in step 1202 are the same as those described above with respect to the L1/L2 signaling for activating cell DTX/DRX. Specifically, in step 1202, UE-specific, UE group-specific, or cell-specific LI signaling may be a DCI format with CRC bits scrambled by a UE-specific, UE group-specific, or cell-specific RNTI, or a PDCCH carrying this DCI format. UE-specific, UE group-specific, or cell-specific L2 signaling may be a MAC CE transmitted on a PDSCH scheduled by a DCI format with CRC bits scrambled by a UE-specific, UE group-specific, or cell-specific RNTI.

The present embodiment provides a specific method by which a network (e.g., RAN node 2) can configure the cell DTX/DRX ON duration to the UE 1. Further details described in the last paragraphs of the first example embodiment may be similarly applied to the present example embodiment.

### THIRD EXAMPLE EMBODIMENT

An example configuration of a radio communication system according to the present example embodiment is the same as the example configuration described with reference to FIG. 1. The present embodiment provides details on the exchange of cell DTX/DRX configurations between RAN nodes.

This example embodiment adopts the cell DTX/DRX ON duration configuration method shown in FIG. 7. The RAN node 2 notifies another RAN node of the cell DTX/DRX pattern of the cell 21. The other RAN node may serve one or more neighboring cells of the cell 21. Specifically, the RAN node 2 explicitly or implicitly informs the other RAN node of how many segments the cell DTX/DRX cycle of the cell 21 is divided into, and also informs the other RAN node of the number of one or more segments that define the ON duration within the cell DTX/DRX cycle. The RAN node 2 sends cell DTX/DRX information including these configurations or indications to the other RAN node using an inter-RAN node control message. The inter-RAN node control message may be an Xn Application Protocol (XnAP) or X2AP message. More specifically, this message may be an XN SETUP REQUEST, XN SETUP RESPONSE, NG-RAN NODE CONFIGURATION UPDATE, or NG-RAN NODE CONFIGURATION UPDATE ACKNOWLEDGE message.

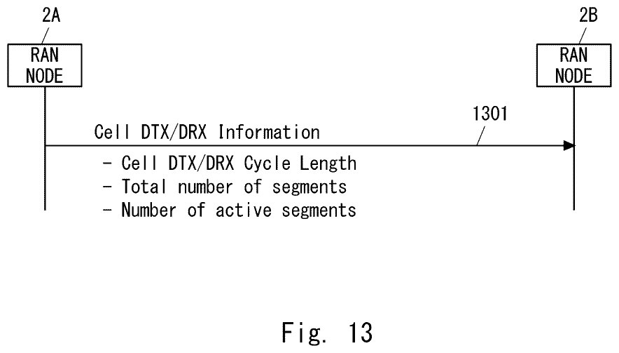

In an example, as shown in FIG. 13, a RAN node 2A sends cell DTX/DRX information 1301 concerning a cell (e.g., cell 21) that it manages to another RAN node 2B. The cell DTX/DRX information 1301 indicates the length of the cell DTX/DRX cycle (i.e., the value of T_{Cell-DTX} in the example shown in FIG. 7), the total number of segments (i.e., the value of N in the example in FIG. 7), and the number of active segments corresponding to the cell DTX/DRX ON duration (i.e., the value of M in the example in FIG. 7). Specifically, the cell DTX/DRX information 1301 includes first to third fields or information elements. The first field or information element indicates the length of the cell DTX/DRX cycle (i.e., T_{Cell-DTX}). The second field or information element indicates the total number of segments (i.e., N). The third field or information element indicates the number of active segments (i.e., M). The second field or information element indicates a dimensionless number that explicitly represents the total number of segments within the cell DTX/DRX cycle. In this example, the RAN node 2B understands that the time length of one segment (i.e., T_{S}) is equal to the largest integer that does not exceed the real number obtained by dividing the length of the cell DTX/DRX cycle (i.e., T_{Cell-DTX}) by the total number of segments (i.e., N). The RAN node 2B understands that the number of segments indicated by the third field or information element, counting from the first segment located at the beginning of the cell DTX/DRX cycle, corresponds to the cell DTX/DRX ON duration. The RAN node 2B may understand that the remaining (N-M) segments are included in the cell DTX/DRX OFF duration. Additionally, the RAN node 2B may understand that the remaining time in the cell DTX/DRX cycle after the N segments is included in the cell DTX/DRX OFF duration.

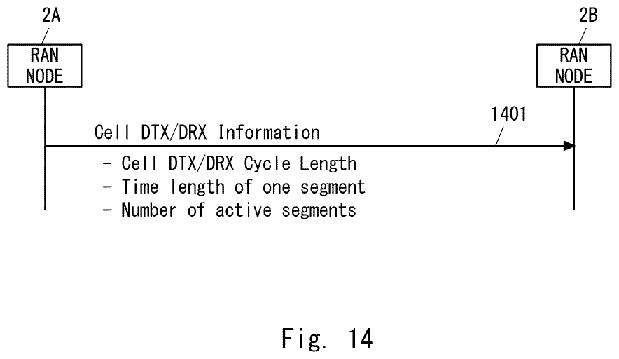

In another example, as shown in FIG. 14, the RAN node 2A sends cell DTX/DRX information 1401 concerning a cell (e.g., cell 21) that it manages to the other RAN node 2B. The cell DTX/DRX information 1401 indicates the length of the cell DTX/DRX cycle (i.e., the value of T_{Cell-DTX} in the example shown in FIG. 7), the time length of one segment (i.e., the value of T_{S} in the example in FIG. 7), and the number of active segments corresponding to the cell DTX/DRX ON duration (i.e., the number M in the example in FIG. 7). Specifically, the cell DTX/DRX information 1401 includes first to third fields or information elements. The first field or information element indicates the length of the cell DTX/DRX cycle (i.e., T_{Cell-DTX}). The second field or information element indicates the time length of one segment (i.e., T_{S}). The third field or information element indicates the number of active segments (i.e., M). In other words, in the example shown in FIG. 14, the RAN node 2A does not need to explicitly notify the RAN node 2B of the total number of segments (i.e., the value of N in the example shown in FIG. 7). The RAN node 2B may understand that the largest integer that does not exceed the real number obtained by dividing the cell DTX/DRX cycle length (i.e., T_{Cell-DTX}) by the segment time length (i.e., T_{S}) is equal to the total number of segments (i.e., N). The RAN node 2B understands that the number of segments indicated by the third field or information element, counting from the first segment located at the beginning of the cell DTX/DRX cycle, corresponds to the ON duration. The RAN node 2B may understand that the remaining (N-M) segments are included in the cell DTX/DRX OFF duration. Additionally, the RAN node 2B may understand that the remaining time in the cell DTX/DRX cycle after the N segments is included in the cell DTX/DRX OFF duration.

In yet another example, the second field or information element in the examples of FIG. 13 or FIG. 14 is modified to indicate both the total number of segments (i.e., N) and the time length of one segment (i.e., T_{S}). As in the examples shown in FIG. 13 and FIG. 14, the RAN node 2B understands that the number of segments indicated by the third field or information element, counting from the first segment located at the beginning of the cell DTX/DRX cycle, corresponds to the ON duration. The RAN node 2B may understand that the remaining (N-M) segments are included in the cell DTX/DRX OFF duration. Additionally, the RAN node 2B may understand that the remaining time in the cell DTX/DRX cycle after the N segments is included in the cell DTX/DRX OFF duration.

As can be understood from the above description, the present embodiment provides a specific method for exchanging cell DTX/DRX configurations, including cell DTX/DRX ON durations, between RAN nodes. The following provides further details of the present embodiment.

The cell DTX/DRX information 1301 and 1401 may further indicate other information. In other words, the cell DTX/DRX information 1301 and 1401 may include additional fields or information elements separate from the fields or information elements described above. Specifically, the cell DTX/DRX information 1301 and 1401 may indicate the start offset of the cell DTX/DRX cycle.

The cell DTX/DRX information 1301 and 1401 may be used by the RAN node 2B to broadcast information indicating the cell DTX/DRX pattern of the cell 21, which is managed by the RAN node 2A, in a different cell managed by the RAN node 2B. The RAN node 2B may broadcast information indicating the cell DTX/DRX pattern of a neighboring cell managed by the RAN node 2A within a cell managed by the RAN node 2B. With these implementations, for example, UEs belonging to a cell managed by the RAN node 2B can consider the cell DTX pattern of a neighboring cell to measure this cell. Alternatively, UEs belonging to a cell managed by the RAN node 2B can consider the cell DTX pattern of a neighbor cell for cell selection, cell reselection, or both.

The cell DTX/DRX information 1301 or 1401 may be contained in a Served Cell Information NR information element (IE). A Served Cell Information NR IE includes cell configuration information of an NR cell that a neighbouring NG-RAN node (e.g., RAN node 2B) may need for the XnAP interface. A Served Cell Information NR IE can be included in an XN SETUP REQUEST, XN SETUP RESPONSE, NG-RAN NODE CONFIGURATION UPDATE, or NG-RAN NODE CONFIGURATION UPDATE ACKNOWLEDGE message.

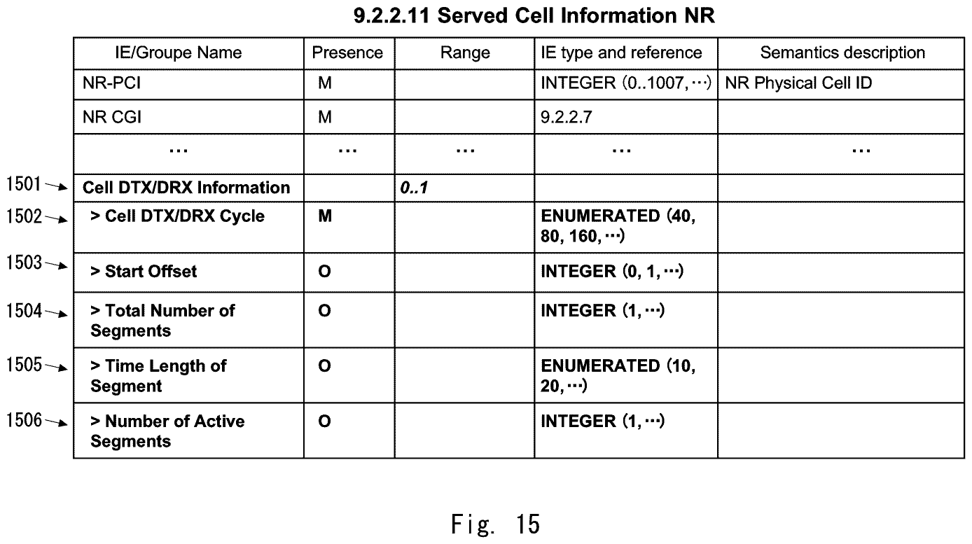

FIG. 15 shows an example of the format of a Served Cell Information NR IE enhanced to contain the cell DTX/DRX information 1301 or 1401. The Served Cell Information NR IE specifies a served cell using a NR Physical Cell Identity (NR-PCI) IE and an NR Cell Global Identity (CGI) IE. In the example in FIG. 15, the Served Cell Information NR IE may optionally include a Cell DTX/DRX Information IE 1501. The Cell DTX/DRX Information IE 1501 indicates the cell DTX/DRX information of the cell identified by the NR-PCI IE and NR CGI IE. The Cell DTX/DRX Information IE 1501 can contain a Cell DTX/DRX Cycle IE 1502, a Start Offset IE 1503, a Total Number of Segments IE 1504, a Time Length of Segment IE 1505, and a Number of Active Segments IE 1506.

The Cell DTX/DRX Cycle IE 1502 indicates the length of the cell DTX/DRX cycle (i.e., T_{Cell-DTX}). The Start Offset IE 1503 indicates the start offset of the cell DTX/DRX cycle. The Total Number of Segments IE 1504 indicates the total number of segments (i.e., N) that divide the cell DTX/DRX cycle. The Time Length of Segment IE 1505 indicates the time length (i.e., T_{S}) of one segment. The Number of Active Segments IE 1506 indicates the number (i.e., M) of active segments that define the cell DTX/DRX ON duration. The information elements contained in the Cell DTX/DRX Information IE 1501 vary depending on specific implementations. Specifically, if the Cell DTX/DRX Information 1301 shown in FIG. 13 is adopted, the Cell DTX/DRX Information IE 1501 need not include the Time Length of Segment IE 1505. On the other hand, if the cell DTX/DRX information 1401 shown in FIG. 14 is adopted, the Cell DTX/DRX Information IE 1501 may not include the Total Number of Segments IE 1504.

### FOURTH EXAMPLE EMBODIMENT

An example configuration of a radio communication system according to the present example embodiment is the same as the example configuration described with reference to FIG. 1. The present embodiment provides an improvement that enables a network to dynamically specify or change the duration of a cell DTX/DRX ON duration.

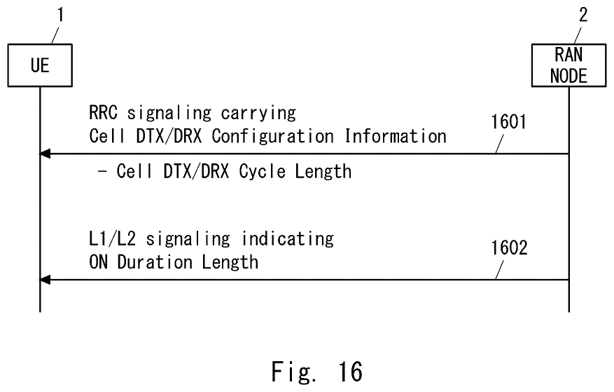

FIG. 16 shows an example of signaling between the UE 1 and the RAN node 2. In step 1601, the RAN node 2 transmits first configuration information indicating the length of the cell DTX/DRX cycle to one or more UEs 1 in the cell 21 via RRC signaling. This RRC signaling may be cell-specific and be broadcast within the cell 21. The cell-specific RRC signaling may be system information, specifically the MIB or a SIB. Alternatively, the RRC signaling may be UE-specific. The first configuration information may indicate other configurations for cell DTX/DRX. Specifically, the first configuration information may indicate the start offset of the cell DTX/DRX cycle.

In step 1602, the RAN node 2 transmits second configuration information indicating the ON duration within the cell DTX/DRX cycle to one or more UEs 1 in the cell 21 via Layer 1 or Layer 2 (L1/L2) signaling. The L1/L2 signaling can be transmitted more dynamically than the RRC signaling. Therefore, the L1/L2 signaling can provide the UEs 1 with a dynamic update of the cell DTX/DRX ON duration.

The L1/L2 signaling in step 1602 may be signaling to activate cell DTX/DRX. In other words, the L1/L2 signaling in step 1602 may indicate the activation of cell DTX/DRX and also specify the ON duration of the cell DTX/DRX to be activated.

Specific examples of the L1/L2 signaling in step 1602 are the same as those described above with respect to the L1/L2 signaling for activating cell DTX/DRX. Specifically, the L1/L2 signaling in step 1602 may be cell-specific, UE group-specific, or UE-specific. UE group-specific or cell-specific LI signaling may be in a DCI format with CRC bits scrambled by a UE group-specific or cell-specific RNTI, or may be a PDCCH carrying this DCI format. The UE group-specific or cell-specific RNTI may be an SI-RNTI or a P-RNTI, or may be an RNTI newly defined for cell DTX/DRX.

According to the operation shown in FIG. 16, the RAN node 2 can dynamically specify or change the time length of the cell DTX/DRX ON duration. For example, the RAN node 2 may dynamically increase or decrease the cell DTX/DRX ON duration according to the traffic condition of the cell 21 or the number of UEs that are active (or in connected mode) in the cell 21.

### FIFTH EXAMPLE EMBODIMENT

An example configuration of a radio communication system according to the present example embodiment is the same as the example configuration described with reference to FIG. 1. The present example embodiment provides improvements in cell selection and reselection.

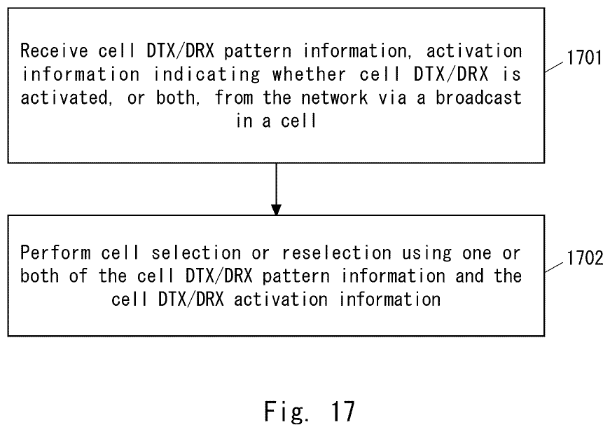

FIG. 17 shows an example of the operation of the UE 1. In step 1701, the UE 1 receives cell DTX/DRX pattern information, activation information indicating whether cell DTX/DRX is activated, or both, from the network (e. g., RAN node 2) via broadcast in the cell 21. The cell DTX/DRX pattern information and the activation information may be transmitted using the same signaling or message, or may be carried by separate signaling or messages. In step 1702, the UE 1 performs cell selection or reselection using one or both of the cell DTX/DRX pattern information and the cell DTX/DRX activation information. With this implementation, the UE 1 can take into account information about the pattern or activation of cell DTX/DRX for NES during cell selection or reselection.

The UE 1 may take into account whether or not cell DTX or cell DRX is activated in the cell 21 in cell selection or cell reselection. For example, if the UE 1 wishes to use a latency-critical service, the UE 1 may select a cell in which cell DTX or cell DRX is deactivated in preference to a cell in which cell DTX or cell DRX is activated in cell selection, cell reselection, or both. Additionally or alternatively, the UE 1 may use the cell DTX/DRX pattern information to perform cell measurements for cell selection, cell reselection, or mobility (e.g., handover or conditional handover) during the cell DTX ON duration. The UE 1 may recognize the cell DTX pattern activated in the cell 21 based on the cell DTX pattern information, or on the cell DTX pattern information and the activation information. Then, the UE 1 may measure the cell 21 for cell selection, cell reselection, or mobility during the cell DTX ON duration of the cell 21. With these implementations, the UE 1 can take into account information about the pattern or activation of cell DTX/DRX for NES in cell measurements. With these implementations, the UE 1 can take into account information about the pattern or activation of cell DTX/DRX for NES in cell selection or reselection. Alternatively, with these implementations, the UE 1 can take into account information about the pattern or activation of cell DTX/DRX for NES in cell measurements.

### SIXTH EXAMPLE EMBODIMENT

An example configuration of a radio communication system according to the present example embodiment is the same as the example configuration described with reference to FIG. 1. The present example embodiment relates to the utilization of cell DTX/DRX pattern information of neighboring cells.

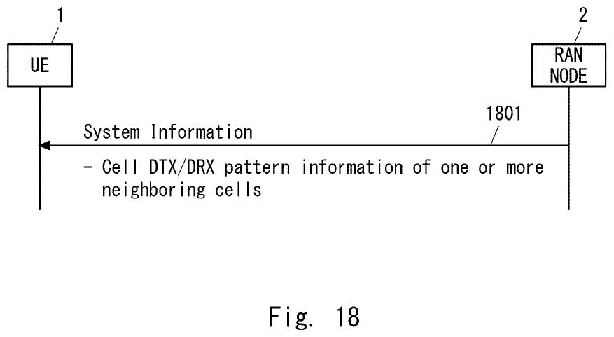

FIG. 18 shows an example of signaling between the UE 1 and the RAN node 2. In step 1801, the RAN node 2 broadcasts, in a first cell (e.g., cell 21), information about the cell DTX/DRX pattern of a second cell. The information may be transmitted using cell-specific RRC signaling. The cell-specific RRC signaling may be system information, specifically the MIB or a SIB. The second cell may be a neighboring cell of the first cell (e. g., cell 21). The RAN node 2 may broadcast the cell DTX/DRX pattern information for each of two or more second cells or neighboring cells.

The second cell may be provided by a RAN node other than the RAN node 2. In this case, the RAN node 2 may receive information about the cell DTX/DRX pattern of the second cell from the other RAN node via an inter-RAN node interface (e.g., the Xn or X2 interface).

The UE 1 may take into account the cell DTX/DRX pattern information of a neighbor cell in cell selection, cell reselection, or both. Additionally or alternatively, the UE 1 may use the cell DTX/DRX pattern information of a neighboring cell to perform neighbor cell measurements for cell selection, cell reselection, or mobility (e.g., handover or conditional handover) during the cell DTX ON duration of the neighboring cell. The UE 1 may perform measurements of a neighboring cell during the cell DTX ON duration of the neighboring cell for cell selection, cell reselection, or mobility.

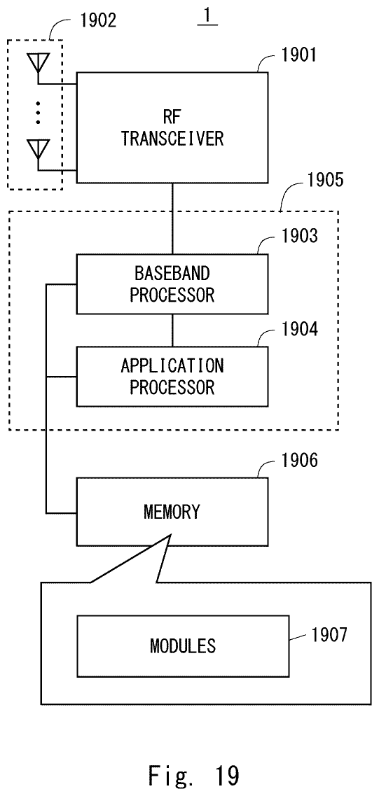

The following describes example configurations of the UE 1 and the RAN node 2 according to the multiple example embodiments described above. FIG. 19 shows a block diagram of an example configuration of the UE 1. The Radio Frequency (RF) transceiver 1901 performs analog RF signal processing to communicate with the RAN node 2. The RF transceiver 1901 may include a plurality of transceivers. The analog RF signal processing performed by the RF transceiver 1901 includes frequency up-conversion, frequency down-conversion, and amplification. The RF transceiver 1901 is coupled with an antenna array 1902 and a baseband processor 1903. The RF transceiver 1901 receives modulated symbol data (or OFDM symbol data) from the baseband processor 1903, generates a transmission RF signal, and supplies the transmission RF signal to the antenna array 1902. The RF transceiver 1901 also generates a baseband received signal based on a received RF signal received by the antenna array 1902, and supplies the baseband received signal to the baseband processor 1903. The RF transceiver 1901 may include an analog beamformer circuit for beamforming. The analog beamformer circuit includes, for example, multiple phase shifters and multiple power amplifiers.

The baseband processor 1903 performs digital baseband signal processing (data-plane processing) and control-plane processing for radio communication. The digital baseband signal processing includes (a) data compression/decompression, (b) data segmentation/concatenation, (c) transmission format (transmission frame) composition/decomposition, (d) channel encoding/decoding, (e) modulation (i.e., symbol mapping)/demodulation, and (f) generation of OFDM symbol data (baseband OFDM signal) using Inverse Fast Fourier Transform (IFFT) and so on. On the other hand, the control-plane processing includes communication management of layer 1 (e.g., transmission power control), layer 2 (e. g., radio resource management, and hybrid automatic repeat request (HARQ) processing), and layer 3 (e.g., signaling related to attach, mobility, and call management).

For example, the digital baseband signal processing performed by the baseband processor 1903 may include signal processing for the Service Data Adaptation Protocol (SDAP) layer, the Packet Data Convergence Protocol (PDCP) layer, the Radio Link Control (RLC) layer, the Medium Access Control (MAC) layer, and the Physical (PHY) layer. The control plane processing performed by the baseband processor 1903 may include processing of the Non-Access Stratum (NAS) protocol, the Radio Resource Control (RRC) protocol, MAC Control Elements (CEs), and Downlink Control Information (DCIs).

The baseband processor 1903 may perform Multiple Input Multiple Output (MIMO) encoding and precoding for beamforming.

The baseband processor 1903 may include a modem processor (e. g., a digital signal processor (DSP)) that performs digital baseband signal processing and a protocol stack processor (e.g., a central processing unit (CPU) or a micro processing unit (MPU)) that performs control plane processing. In this case, the protocol stack processor that performs control plane processing may be integrated with an application processor 1904 described later.

The application processor 1904 is also referred to as a CPU, MPU, microprocessor, or processor core. The application processor 1904 may include a plurality of processors (a plurality of processor cores). The application processor 1904 executes a system software program (operating system (OS)) and various application programs (e.g., call application, web browser, mailer, camera operation application, music player application) read from a memory 1906 or from another memory, thereby realizing various functions of the UE 1.

In some implementations, as shown by the dashed line (1905) in FIG. 19, the baseband processor 1903 and the application processor 1904 may be integrated on a single chip. In other words, the baseband processor 1903 and the application processor 1904 may be implemented as a single System on Chip (SoC) device 1905. The SoC device may also be referred to as a system large-scale integration (LSI) or chipset.

The memory 1906 is a volatile memory or a non-volatile memory or a combination thereof. The memory 1906 may include a plurality of physically independent memory devices. The volatile memory is, for example, Static Random Access Memory (SRAM), Dynamic RAM (DRAM), or a combination thereof. The non-volatile memory is, for example, Mask Read Only Memory (MROM), Electrically Erasable Programmable ROM (EEPROM), flash memory, or a hard disk drive, or any combination thereof. For example, the memory 1906 may include an external memory device that is accessible by the baseband processor 1903, the application processor 1904, and the SoC 1905. The memory 1906 may include an internal memory device that is integrated into the baseband processor 1903, the application processor 1904, or the SoC 1905. In addition, the memory 1906 may include memory within a Universal Integrated Circuit Card (UICC).

The memory 1906 may store one or more software modules (or computer programs) 1907 that include a set of instructions and data for performing the processing by the UE 1 described in the above example embodiments. In some implementations, the baseband processor 1903 or the application processor 1904 may be configured to read and execute the software modules 1907 from the memory 1906, thereby performing the processing of the UE 1 as described in the example embodiments with reference to the drawings.

The control plane processing and operations performed by the UE 1 described in the above example embodiment can be implemented by elements other than the RF transceiver 1901 and the antenna array 1902, namely at least one of the baseband processor 1903 and the application processor 1904, and the memory 1906 that stores the software modules 1907.

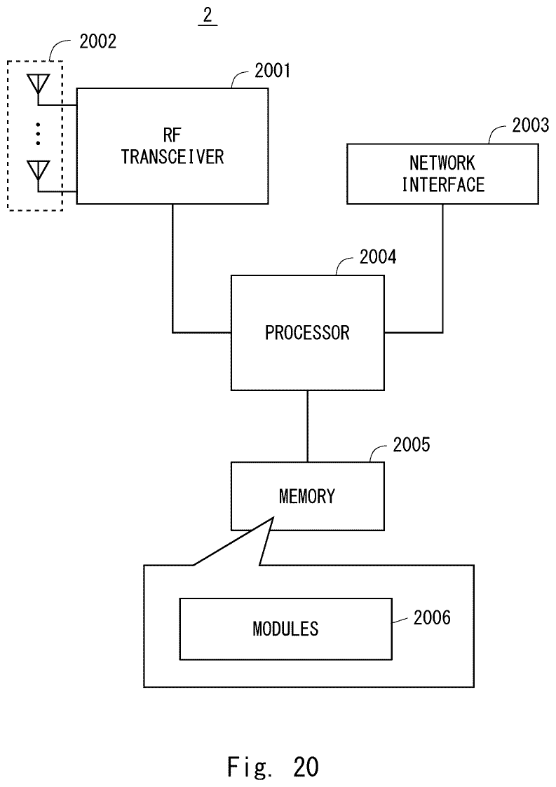

FIG. 20 is a block diagram showing an example of the configuration of the RAN node 2 according to the example embodiments described above. Referring to FIG. 20, the RAN node 2 includes a Radio Frequency (RF) transceiver 2001, a network interface 2003, a processor 2004, and a memory 2005. The RF transceiver 2001 performs analog RF signal processing to communicate with the UEs 1. The RF transceiver 2001 may include a plurality of transceivers. The RF transceiver 2001 is coupled to an antenna array 2002 and the processor 2004. The RF transceiver 2001 receives modulated symbol data from the processor 2004, generates a transmission RF signal, and supplies the transmission RF signal to the antenna array 2002. The RF transceiver 2001 generates a baseband reception signal based on a reception RF signal received by the antenna array 2002 and supplies the baseband reception signal to the processor 2004. The RF transceiver 2001 may include an analog beamformer circuit for beamforming. The analog beamformer circuit includes, for example, a plurality of phase shifters and a plurality of power amplifiers.

The network interface 2003 is used to communicate with network nodes (e.g., other RAN nodes, as well as control nodes and transfer nodes in the core network). For example, the network interface 2003 may include a network interface card (NIC) conforming to the IEEE 802.3 series.

The processor 2004 performs digital baseband signal processing (data plane processing) and control plane processing for radio communication. The processor 2004 may include a plurality of processors. For example, the processor 2004 may include a modem processor (e.g., a digital signal processor (DSP)) that performs digital baseband signal processing and a protocol stack processor (e.g., a central processing unit (CPU) or a micro processing unit (MPU)) that performs control plane processing. The processor 2004 may include a digital beamformer module for beamforming. The digital beamformer module may include a Multiple Input Multiple Output (MIMO) encoder and precoder.

The memory 2005 is composed of a combination of a volatile memory and a non-volatile memory. The volatile memory is, for example, Static Random Access Memory (SRAM) or Dynamic RAM (DRAM) or a combination thereof. The non-volatile memory is Mask Read Only Memory (MROM), Electrically Erasable Programmable ROM (EEPROM), flash memory, or a hard disk drive, or any combination thereof. The memory 2005 may include storage located separate from the processor 2004. In this case, the processor 2004 may access the memory 2005 via a network interface 2003 or another I/O interface.

The memory 2005 may store one or more software modules (computer programs) 2006 containing instructions and data for performing the processing by the RAN node 2 described in the above example embodiments. In some implementations, the processor 2004 may be configured to execute the software modules 2006 read from the memory 2005, thereby performing the processing of the RAN node 2 described in the above example embodiments.

In a case where the RAN node 2 is a CU (e.g., gNB-CU) or a CU-CP (e.g., gNB-CU-CP), the RAN node 2 may not include the RF transceiver 2001 (and the antenna array 2002).

As explained using FIGS. 19 and 20, each of the processors of the UE 1 and RAN node 2 in the above example embodiments can execute one or more programs, containing a set of instructions, to cause a computer to perform an algorithm described with reference to the drawings. Each of these programs contains a set of instructions (or software codes) that, if loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered trademark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustic, or other form of propagated signals.

The above example embodiments are merely examples of the application of the technical concepts obtained by the inventors. These technical concepts are not limited to the above example embodiments and may be modified in various ways.

For example, the whole or part of the example embodiments disclosed above can be described as, but not limited to, the following supplementary notes. Of course, some or all of the elements (e. g., configurations and functionality) described in the Supplementary Notes directed to a device (e.g., radio access network node, radio terminal) may also be described as or in Supplementary Notes directed to methods and programs. For example, some or all of the elements listed in Supplementary Notes 2-14 that depend on Supplementary Note 1 may also be listed as Supplementary Notes that depend on Supplementary Note 29 or 31 with the same dependency as Supplementary Notes 2-14. Similarly, some or all of the elements listed in Supplementary Notes 16-28 that depend on Supplementary Note 15 may also be listed as Supplementary Notes that depend on Supplementary Note 30 or 32 with the same dependency as Supplementary Notes 16-28. Some or all of the elements described in a Supplementary Note may be applicable to various hardware, software, storage for storing software, systems, and methods.

### Supplementary Note 1

A radio access network node comprising:
means for transmitting configuration information for cell discontinuous transmission (DTX) or cell discontinuous reception (DRX) to one or more radio terminals in a cell, wherein
the configuration information includes a first field or information element indicating a length of a cycle of the cell DTX or cell DRX, and
the configuration information further includes a second field or information element that explicitly or implicitly indicates how many segments the cycle is divided into, and a third field or information element that indicates a number of one or more segments that define an ON duration of the cell DTX or cell DRX within the cycle.

### Supplementary Note 2

The radio access network node according to Supplementary Note 1, wherein the second field or information element includes a field or information element that explicitly indicates a dimensionless number representing a total number of a plurality of segments within the cycle.

### Supplementary Note 3

The radio access network node according to Supplementary Note 2, wherein the second field or information element further includes a field or information element that explicitly indicates a time length of each segment.

### Supplementary Note 4

The radio access network node according to Supplementary Note 1, wherein
the second field or information element explicitly indicates a time length of each segment, and
the second field or information element implicitly indicates how many segments the cycle is divided into by a value obtained by dividing the length of the cycle by the time length of each segment.

### Supplementary Note 5

The radio access network node according to any one of Supplementary Notes 1 to 4, wherein
the length of the cycle is specified in milliseconds, slots, subframes, or radio frames, and
the time length of each segment is equal to or greater than two milliseconds, two slots, two subframes, or two radio frames.

### Supplementary Note 6

The radio access network node according to any one of Supplementary Notes 1 to 4, wherein
the length of the cycle is specified in units of subframes, and the time length of each segment is specified in units of slots.

### Supplementary Note 7

The radio access network node according to any one of Supplementary Notes 1 to 4, wherein
the length of the cycle is specified in units of radio frames, and the time length of each segment is specified in units of subframes or slots.

### Supplementary Note 8

The radio access network node according to any one of Supplementary Notes 1 to 7, wherein the third field or information element notifies the one or more radio terminals that a number of segments indicated by the third field or information element, counting from a first segment located at the beginning of the cycle, correspond to the ON duration.

### Supplementary Note 9

The radio access network node according to any one of Supplementary Notes 1 to 8, wherein the means for transmitting is adapted to broadcast the configuration information via cell-specific Radio Resource Control (RRC) signaling in the cell.

### Supplementary Note 10

The radio access network node according to Supplementary Note 9, wherein the configuration information indicates that the cell DTX or cell DRX is activated in the cell.

### Supplementary Note 11

The radio access network node according to Supplementary Note 9 or 10, wherein the configuration information is used by the one or more radio terminals for one or both of cell selection and cell reselection.

### Supplementary Note 12

The radio access network node according to any one of Supplementary Notes 9 to 11, wherein the configuration information is used by the one or more radio terminals to perform measurements for cell selection, cell reselection, or mobility during the ON duration of the cell DTX.

### Supplementary Note 13

The radio access network node according to any one of Supplementary Notes 9 to 12, wherein the cell-specific RRC signaling is a Master Information Block (MIB) or a System Information Block.

### Supplementary Note 14

The radio access network node according to any one of Supplementary Notes 1 to 8, wherein the means for transmitting is adapted to:
transmit the first field or information element and the second field or information element via cell-specific or radio terminal-specific Radio Resource Control (RRC) signaling; and
transmit the third field or information element via cell-specific, radio terminal group-specific, or radio terminal-specific Layer 1 or Layer 2 signaling, which is more dynamic than the RRC signaling.

### Supplementary Note 15

A radio terminal comprising:
means for receiving configuration information for cell discontinuous transmission (DTX) or cell discontinuous reception (DRX) from a network, wherein
the configuration information includes a first field or information element indicating a length of a cycle of the cell DTX or cell DRX, and
the configuration information further includes a second field or information element that explicitly or implicitly indicates how many segments the cycle is divided into, and a third field or information element that indicates a number of one or more segments that define an ON duration of the cell DTX or cell DRX within the cycle.

### Supplementary Note 16

The radio terminal according to Supplementary Note 15, wherein the second field or information element includes a field or information element that explicitly indicates a dimensionless number representing a total number of a plurality of segments within the cycle.

### Supplementary Note 17

The radio terminal according to Supplementary Note 16, wherein the second field or information element further includes a field or information element that explicitly indicates a time length of each segment.

### Supplementary Note 18

The radio terminal according to Supplementary Note 15, wherein
the second field or information element explicitly indicates a time length of each segment, and
the radio terminal further comprises means for recognizing how many segments the cycle is divided into, based on a value obtained by dividing the length of the cycle by the time length of each segment.

### Supplementary Note 19

The radio terminal according to any one of Supplementary Notes 15 to 18, wherein
the length of the cycle is specified in milliseconds, slots, subframes, or radio frames, and
the time length of each segment is equal to or greater than two milliseconds, two slots, two subframes, or two radio frames.

### Supplementary Note 20

The radio terminal according to any one of Supplementary Notes 15 to 18, wherein
the length of the cycle is specified in units of subframes, and
the time length of each segment is specified in units of slots.

### Supplementary Note 21

The radio terminal according to any one of Supplementary Notes 15 to 18, wherein
the length of the cycle is specified in units of radio frames, and
the time length of each segment is specified in units of subframes or slots.

### Supplementary Note 22

The radio terminal according to any one of Supplementary Notes 15 to 21, further comprising means for recognizing that a number of segments indicated by the third field or information element, counting from a first segment located at the beginning of the cycle, correspond to the ON duration.

### Supplementary Note 23

The radio terminal according to any one of Supplementary Notes 15 to 22, wherein the means for receiving is adapted to receive the configuration information via cell-specific Radio Resource Control (RRC) signaling.

### Supplementary Note 24

The radio terminal according to Supplementary Note 23, wherein the configuration information indicates that the cell DTX or cell DRX is activated in the cell.

### Supplementary Note 25

The radio terminal according to Supplementary Note 23 or 24, further comprising means for performing one or both of cell selection and cell reselection using the configuration information.

### Supplementary Note 26

The radio terminal according to any one of Supplementary Notes 23 to 25, further comprising means for recognizing a pattern of the cell DTX based on the configuration information and performing measurements for cell selection, cell reselection, or mobility during the ON duration of the cell DTX.

### Supplementary Note 27

The radio terminal according to any one of Supplementary Notes 23 to 26, wherein the cell-specific RRC signaling is a Master Information Block (MIB) or a System Information Block.

### Supplementary Note 28

The radio terminal according to any one of Supplementary Notes 15 to 22, wherein the means for receiving is adapted to:
receive the first field or information element and the second field or information element via cell-specific or radio terminal-specific Radio Resource Control (RRC) signaling; and
receive the third field or information element via cell-specific, radio terminal group-specific, or radio terminal-specific Layer 1 or Layer 2 signaling, which is more dynamic than the RRC signaling.

### Supplementary Note 29

A method performed by a radio access network node, comprising:
transmitting configuration information for cell discontinuous transmission (DTX) or cell discontinuous reception (DRX) to one or more radio terminals in a cell, wherein
the configuration information includes a first field or information element indicating a length of a cycle of the cell DTX or cell DRX, and
the configuration information further includes a second field or information element that explicitly or implicitly indicates how many segments the cycle is divided into, and a third field or information element that indicates a number of one or more segments that define an ON duration of the cell DTX or cell DRX within the cycle.

### Supplementary Note 30

A method performed by a radio terminal, comprising:
receiving configuration information for cell discontinuous transmission (DTX) or cell discontinuous reception (DRX) from a wherein
the configuration information includes a first field or information element indicating a length of a cycle of the cell DTX or cell DRX, and
the configuration information further includes a second field or information element that explicitly or implicitly indicates how many segments the cycle is divided into, and a third field or information element that indicates a number of one or more segments that define an ON duration of the cell DTX or cell DRX within the cycle.

### Supplementary Note 31

A program for causing a computer to perform a method for a radio access network node,
the method comprising transmitting configuration information for cell discontinuous transmission (DTX) or cell discontinuous reception (DRX) to one or more radio terminals in a cell, wherein
the configuration information includes a first field or information element indicating a length of a cycle of the cell DTX or cell DRX, and
the configuration information further includes a second field or information element that explicitly or implicitly indicates how many segments the cycle is divided into, and a third field or information element that indicates a number of one or more segments that define an ON duration of the cell DTX or cell DRX within the cycle.

### Supplementary Note 32

A program for causing a computer to perform a method for a radio terminal,
the method comprising receiving configuration information for cell discontinuous transmission (DTX) or cell discontinuous reception (DRX) from a network, wherein
the configuration information includes a first field or information element indicating a length of a cycle of the cell DTX or cell DRX, and
the configuration information further includes a second field or information element that explicitly or implicitly indicates how many segments the cycle is divided into, and a third field or information element that indicates a number of one or more segments that define an ON duration of the cell DTX or cell DRX within the cycle.

### Supplementary Note 33

A radio access network node comprising:
means for sending configuration information for cell discontinuous transmission (DTX) or cell discontinuous reception (DRX) of a cell managed by the radio access network node to another radio access network node, wherein
the configuration information includes a first field or information element indicating a length of a cycle of the cell DTX or cell DRX, and
the configuration information further includes a second field or information element that explicitly or implicitly indicates how many segments the cycle is divided into, and a third field or information element that indicates a number of one or more segments that define an ON duration of the cell DTX or cell DRX within the cycle.

### Supplementary Note 34

The radio access network node according to Supplementary Note 33, wherein the second field or information element includes a field or information element that explicitly indicates a dimensionless number representing a total number of a plurality of segments within the cycle.

### Supplementary Note 35

The radio access network node according to Supplementary Note 34, wherein the second field or information element further includes a field or information element that explicitly indicates a time length of each segment.

### Supplementary Note 36

The radio access network node according to Supplementary Note 33, wherein
the second field or information element explicitly indicates a time length of each segment, and
the second field or information element implicitly indicates how many segments the cycle is divided into by a value obtained by dividing the length of the cycle by the time length of each segment.

### Supplementary Note 37

The radio access network node according to any one of Supplementary Notes 33 to 36, wherein
the length of the cycle is specified in milliseconds, slots, subframes, or radio frames, and
the time length of each segment is equal to or greater than two milliseconds, two slots, two subframes, or two radio frames.

### Supplementary Note 38

The radio access network node according to any one of Supplementary Notes 33 to 36, wherein
the length of the cycle is specified in units of subframes, and
the time length of each segment is specified in units of slots.

### Supplementary Note 39

The radio access network node according to any one of Supplementary Notes 33 to 36, wherein
the length of the cycle is specified in units of radio frames, and
the time length of each segment is specified in units of subframes or slots.

### Supplementary Note 40

The radio access network node according to any one of Supplementary Notes 33 to 39, wherein the third field or information element notifies the other radio access network node that a number of segments indicated by the third field or information element, counting from a first segment located at the beginning of the cycle, correspond to the ON duration.

### Supplementary Note 41

The radio access network node according to any one of Supplementary Notes 33 to 40, wherein the configuration information is used by the other radio access network node to broadcast, in another cell managed by the other radio access network node, information indicating a pattern of the cell DTX or cell DRX of the cell managed by the radio access network node.

### Supplementary Note 42

A method performed by a radio access network node, comprising:
sending configuration information for cell discontinuous transmission (DTX) or cell discontinuous reception (DRX) of a cell managed by the radio access network node to another radio access network node, wherein
the configuration information includes a first field or information element indicating a length of a cycle of the cell DTX or cell DRX, and
the configuration information further includes a second field or information element that explicitly or implicitly indicates how many segments the cycle is divided into, and a third field or information element that indicates a number of one or more segments that define an ON duration of the cell DTX or cell DRX within the cycle.

### Supplementary Note 43

A radio terminal comprising:
means for receiving, from a network, connected mode discontinuous reception (CDRX) configuration information indicating a length of a cycle of CDRX, a start offset of the CDRX, and a length of an ON duration timer of the CDRX;
means for receiving cell discontinuous transmission (DTX) or cell DRX configuration information related to cell DTX or cell DRX from the network; and
means for recognizing a pattern of the cell DRX or cell DRX based on the CDRX configuration information and the cell DTX or cell DRX configuration information, wherein
the means for recognizing is adapted to:
   consider a length of a cycle of the cell DTX or cell DRX to be equal to the length of the cycle of the CDRX;
   consider a start offset of the cell DTX or cell DRX to be equal to the start offset of the CDRX;
   consider a time length of a segment for defining an ON duration of the cell DTX or cell DRX to be equal to the length of the ON duration timer of the CDRX; and
   recognize how many segments the cycle of the cell DTX or cell DRX is divided into based on a value obtained by dividing the length of the cycle of the cell DTX or cell DRX by the time length of the segment,
   the cell DTX or cell DRX configuration information indicates a number of one or more segments that define the ON duration of the cell DTX or cell DRX within the cycle of the cell DTX or cell DRX, and
   the means for recognizing is adapted to understand that a number of segments indicated by the cell DTX or cell DRX configuration information, counting from a first segment located at the beginning of the cycle of the cell DTX or cell DRX, corresponds to the ON duration of the cell DTX or cell DRX.

### Supplementary Note 44

The radio terminal according to Supplementary Note 43, wherein
the CDRX configuration information is transmitted from the network via radio terminal-specific Radio Resource Control (RRC) signaling, and
the cell DTX or cell DRX configuration information is transmitted from the network via cell-specific, radio terminal group-specific, or radio terminal-specific Layer 1, Layer 2, or Layer 3 signaling.

### Supplementary Note 45

A method performed by a radio terminal, comprising:
receiving, from a network, connected mode discontinuous reception (CDRX) configuration information indicating a length of a cycle of CDRX, a start offset of the CDRX, and a length of an ON duration timer of the CDRX;
receiving cell discontinuous transmission (DTX) or cell DRX configuration information related to cell DTX or cell DRX from the network; and
recognizing a pattern of the cell DRX or cell DRX based on the CDRX configuration information and the cell DTX or cell DRX configuration information, wherein
the recognizing comprises:
   considering a length of a cycle of the cell DTX or cell DRX to be equal to the length of the cycle of the CDRX;
   considering a start offset of the cell DTX or cell DRX to be equal to the start offset of the CDRX;
   considering a time length of a segment for defining an ON duration of the cell DTX or cell DRX to be equal to the length of the ON duration timer of the CDRX; and
   recognizing how many segments the cycle of the cell DTX or cell DRX is divided into based on a value obtained by dividing the length of the cycle of the cell DTX or cell DRX by the time length of the segment,
the cell DTX or cell DRX configuration information indicates a number of one or more segments that define the ON duration of the cell DTX or cell DRX within the cycle of the cell DTX or cell DRX, and
the recognizing comprises understanding that a number of segments indicated by the cell DTX or cell DRX configuration information, counting from a first segment located at the beginning of the cycle of the cell DTX or cell DRX, corresponds to the ON duration of the cell DTX or cell DRX.

### Supplementary Note 46

A radio access network node comprising:
means for transmitting first configuration information indicating a length of a cycle of cell discontinuous transmission (DTX) or cell discontinuous reception (DRX) to one or more radio terminals in a cell via Radio Resource Control (RRC) signaling; and
means for transmitting second configuration information indicating an ON duration of the cell DTX or cell DRX within the cycle of the cell DTX or cell DRX to one or more radio terminals in the cell via Layer 1 or Layer 2 signaling.

### Supplementary Note 47

The radio access network node according to Supplementary Note 46, wherein the RRC signaling is cell-specific and broadcast in the cell.

### Supplementary Note 48

The radio access network node according to Supplementary Note 46 or 47, wherein the Layer 1 or Layer 2 signaling is cell-specific or radio terminal group-specific.

### Supplementary Note 49

The radio access network node according to Supplementary Note 48, wherein the Layer 1 or Layer 2 signaling is a Downlink Control Information (DCI) format with Cyclic Redundancy Check (CRC) bits scrambled by a cell-specific or radio terminal group-specific Radio Network Temporary Identifier (RNTI).

### Supplementary Note 50

The radio access network node according to any one of Supplementary Notes 46 to 49, wherein the Layer 1 or Layer 2 signaling indicates a dynamic update of the ON duration.

### Supplementary Note 51

The radio access network node according to any one of Supplementary Notes 46 to 50, wherein the first configuration information further indicates a start offset of the cycle.

### Supplementary Note 52

A radio terminal comprising:
means for receiving first configuration information indicating a length of a cycle of cell discontinuous transmission (DTX) or cell discontinuous reception (DRX) from a network via Radio Resource Control (RRC) signaling; and
means for receiving second configuration information indicating an ON duration of the cell DTX or cell DRX within the cycle of the cell DTX or cell DRX from the network via Layer 1 or Layer 2 signaling.

### Supplementary Note 53

The radio terminal according to Supplementary Note 52, wherein the RRC signaling is cell-specific and broadcast in the cell.

### Supplementary Note 54

The radio terminal according to Supplementary Note 52 or 53, wherein the Layer 1 or Layer 2 signaling is cell-specific or radio terminal group-specific.

### Supplementary Note 55

The radio terminal according to Supplementary Note 54, wherein the Layer 1 or Layer 2 signaling is a Downlink Control Information (DCI) format with Cyclic Redundancy Check (CRC) bits scrambled by a cell-specific or radio terminal group-specific Radio Network Temporary Identifier (RNTI).

### Supplementary Note 56

The radio terminal according to any one of Supplementary Notes 52 to 55, wherein the Layer 1 or Layer 2 signaling indicates a dynamic update of the ON duration.

### Supplementary Note 57

The radio terminal according to any one of Supplementary Notes 52 to 56, wherein the first configuration information further indicates a start offset of the cycle.

### Supplementary Note 58

A method performed by a radio access network node, comprising:
transmitting first configuration information indicating a length of a cycle of cell discontinuous transmission (DTX) or cell discontinuous reception (DRX) to one or more radio terminals in a cell via Radio Resource Control (RRC) signaling; and
transmitting second configuration information indicating an ON duration of the cell DTX or cell DRX within the cycle of the cell DTX or cell DRX to one or more radio terminals in the cell via Layer 1 or Layer 2 signaling.

### Supplementary Note 59

A method performed by a radio terminal, comprising:
receiving first configuration information indicating a length of a cycle of cell discontinuous transmission (DTX) or cell discontinuous reception (DRX) from a network via Radio Resource Control (RRC) signaling; and
receiving second configuration information indicating an ON duration of the cell DTX or cell DRX within the cycle of the cell DTX or cell DRX from the network via Layer 1 or Layer 2 signaling.

### Supplementary Note 60

A radio terminal comprising:
means for receiving from a network, via broadcast in a cell, pattern information for cell discontinuous transmission (DTX) or cell discontinuous reception (DRX), or activation information indicating whether the cell DTX or cell DRX is activated, or both; and
means for performing one or both of cell selection and cell reselection using one or both of the pattern information and the activation information.

### Supplementary Note 61

The radio terminal according to Supplementary Note 60, wherein the means for performing is adapted to take into account whether or not the cell DTX or cell DRX is activated in the cell during the cell selection or cell reselection.

### Supplementary Note 62

The radio terminal according to Supplementary Note 60, wherein the means for performing is adapted to, if the radio terminal wishes to use a latency-critical service, select, in the cell selection or reselection, a cell in which the cell DTX or cell DRX is deactivated in preference to a cell in which the cell DTX or cell DRX is activated.

### Supplementary Note 63

The radio terminal according to Supplementary Note 60, wherein the means for performing is adapted to perform measurements for cell selection, cell reselection, or mobility during an ON duration in a cell DTX pattern obtained from the pattern information or from the pattern information and the activation information.

### Supplementary Note 64

A method performed by a radio terminal, comprising:
receiving from a network, via broadcast in a cell, pattern information for cell discontinuous transmission (DTX) or cell discontinuous reception (DRX), or activation information indicating whether the cell DTX or cell DRX is activated, or both; and
performing one or both of cell selection and cell reselection using one or both of the pattern information and the activation information.

### Supplementary Note 65

A radio access network node comprising:
means for broadcasting, in a first cell, information about a cell discontinuous transmission (DTX) or cell discontinuous reception (DRX) pattern of a second cell.

### Supplementary Note 66

The radio access network node according to Supplementary Note 65, wherein the information is used by a radio terminal for cell selection or cell reselection.

### Supplementary Note 67

The radio access network node according to Supplementary Note 65, wherein the information is used by a radio terminal to perform measurements of the second cell for cell selection, cell reselection, or mobility during an ON duration in the cell DTX pattern of the second cell.

### Supplementary Note 68

The radio access network node according to any one of Supplementary Notes 65 to 67, wherein the second cell is managed by another radio access network node different from the radio access network node.

### Supplementary Note 69

A radio terminal comprising:
means for receiving from a network, via broadcast in a first cell, information about a cell discontinuous transmission (DTX) or cell discontinuous reception (DRX) pattern of a second cell.

### Supplementary Note 70

The radio terminal according to Supplementary Note 69, further comprising means for considering the information during one or both of cell selection and cell reselection.

### Supplementary Note 71

The radio terminal according to Supplementary Note 69 or 70, further comprising means for performing measurements of the second cell for cell selection, cell reselection, or mobility during an ON duration in the cell DTX pattern of the second cell obtained from the information.

### Supplementary Note 72

A method performed by a radio access network node, comprising:
broadcasting, in a first cell, information about a cell discontinuous transmission (DTX) or cell discontinuous reception (DRX) pattern of a second cell.

### Supplementary Note 73

A method performed by a radio terminal, comprising:
receiving from a network, via broadcast in a first cell, information about a cell discontinuous transmission (DTX) or cell discontinuous reception (DRX) pattern of a second cell.

This application is based upon and claims the benefit of priority from Japanese Patent Application No. 2023-070075, filed on Apr. 21, 2023, the disclosure of which is incorporated herein in its entirety by reference.

### REFERENCE SIGNS LIST

1 UE
2 RAN node
21 Cell
1903 Baseband processor
1904 Application processor
1906 Memory
1907 Modules
2004 Processor
2005 Memory
2006 Modules

What is claimed is:

1. A radio access network node comprising:
at least one memory; and
at least one processor coupled to the at least one memory and configured to transmit configuration information for one or both of cell discontinuous transmission (DTX) and cell discontinuous reception (DRX) to one or more radio terminals in a cell, wherein
the configuration information includes a first field or information element indicating a length of a cycle of the one or both of cell DTX and cell DRX, and
the configuration information further includes a second field or information element that explicitly or implicitly indicates how many segments the cycle is divided into, and a third field or information element that indicates a number of one or more segments that define an ON duration of the one or both of cell DTX and cell DRX within the cycle.

2. The radio access network node according to claim 1, wherein the second field or information element includes a field or information element that explicitly indicates a dimensionless number representing a total number of a plurality of segments within the cycle.

3. (canceled)

4. The radio access network node according to claim 1, wherein
the second field or information element explicitly indicates a time length of each segment, and
the second field or information element implicitly indicates how many segments the cycle is divided into by a value obtained by dividing the length of the cycle by the time length of each segment.

5-8. (canceled)

9. The radio access network node according to claim 1, wherein the at least one processor is configured to broadcast the configuration information via cell-specific Radio Resource Control (RRC) signaling in the cell.

10-13. (canceled)

14. The radio access network node according to claim 1, wherein the at least one processor is configured to:
transmit the first field or information element and the second field or information element via cell-specific or radio terminal-specific Radio Resource Control (RRC) signaling; and
transmit the third field or information element via cell-specific, radio terminal group-specific, or radio terminal-specific Layer 1 or Layer 2 signaling, which is more dynamic than the RRC signaling.

15. A radio terminal comprising:
at least one memory; and
at least one processor coupled to the at least one memory and configured to receive configuration information for one or both of cell discontinuous transmission (DTX) and cell discontinuous reception (DRX) from a network, wherein
the configuration information includes a first field or information element indicating a length of a cycle of the one or both of cell DTX and cell DRX, and
the configuration information further includes a second field or information element that explicitly or implicitly indicates how many segments the cycle is divided into, and a third field or information element that indicates a number of one or more segments that define an ON duration of the one or both of cell DTX and cell DRX within the cycle.

16. The radio terminal according to claim 15, wherein the second field or information element includes a field or information element that explicitly indicates a dimensionless number representing a total number of a plurality of segments within the cycle.

17. The radio terminal according to claim 16, wherein the second field or information element further includes a field or information element that explicitly indicates a time length of each segment.

18. The radio terminal according to claim 15, wherein
the second field or information element explicitly indicates a time length of each segment, and
the at least one processor is configured to recognize how many segments the cycle is divided into, based on a value obtained by dividing the length of the cycle by the time length of each segment.

19. The radio terminal according to claim 15, wherein
the length of the cycle is specified in milliseconds, slots, subframes, or radio frames, and
the time length of each segment is equal to or greater than two milliseconds, two slots, two subframes, or two radio frames.

20. The radio terminal according to claim 15, wherein
the length of the cycle is specified in units of subframes, and
the time length of each segment is specified in units of slots.

21. The radio terminal according to claim 15, wherein
the length of the cycle is specified in units of radio frames, and
the time length of each segment is specified in units of subframes or slots.

22. The radio terminal according to claim 15, wherein the at least one processor is configured to recognize that a number of segments indicated by the third field or information element, counting from a first segment located at the beginning of the cycle, correspond to the ON duration.

23. The radio terminal according to claim 15, wherein the at least one processor is configured to receive the configuration information via cell-specific Radio Resource Control (RRC) signaling.

24. The radio terminal according to claim 23, wherein the configuration information indicates that the one or both of cell DTX and cell DRX is activated in the cell.

25. The radio terminal according to claim 23, wherein the at least one processor is configured to perform one or both of cell selection and cell reselection using the configuration information.

26. The radio terminal according to claim 23, wherein the at least one processor is configured to recognize a pattern of the cell DTX based on the configuration information and perform measurements for cell selection, cell reselection, or mobility during the ON duration of the cell DTX.

27. The radio terminal according to claim 23, wherein the cell-specific RRC signaling is a Master Information Block (MIB) or a System Information Block.

28. The radio terminal according to claim 15, wherein the at least one processor is configured to:
receive the first field or information element and the second field or information element via cell-specific or radio terminal-specific Radio Resource Control (RRC) signaling; and
receive the third field or information element via cell-specific, radio terminal group-specific, or radio terminal-specific Layer 1 or Layer 2 signaling, which is more dynamic than the RRC signaling.

29. (Canceled)

30. A method performed by a radio terminal, comprising:
receiving configuration information for one or both of cell discontinuous transmission (DTX) and cell discontinuous reception (DRX) from a network, wherein
the configuration information includes a first field or information element indicating a length of a cycle of the one or both of cell DTX and cell DRX, and
the configuration information further includes a second field or information element that explicitly or implicitly indicates how many segments the cycle is divided into, and a third field or information element that indicates a number of one or more segments that define an ON duration of the one or both of cell DTX and cell DRX within the cycle.

31-73. (canceled)
